(19) United States
(12) Patent Application Publication
(10) Pub. No.: US 2016/0358445 A1
(43) Pub. Date: Dec. 8, 2016

(54) ROUTE GUIDANCE SYSTEM, ROUTE GUIDANCE METHOD, AND MOBILE DEVICE

(71) Applicant: Kyocera Corporation, Kyoto-shi (JP)

(72) Inventor: Atsushi ISHll, Osaka (JP)

(21) Appl. No.: 15/240,957

(22) Filed: Aug. 18, 2016

Related U.S. Application Data
(63) Continuation-in-part of application No. PCT/JP2015/054853, filed on Feb. 20, 2015.

(30) Foreign Application Priority Data
Feb. 21, 2014 (JP) 2014-031822

(51) Int. Cl. G08B 21/02; G08B 25/01; G01C 21/34; G01C 21/36; G09B 29/00; G09B 29/10

(52) U.S. Cl. CPC G08B 21/0269; G09B 29/007; G09B 29/106; G01C 21/3438; G01C 21/362; G01C 21/3629; G01C 21/3632; G01C 21/3667; G08B 25/016; G08B 21/0286; G08B 21/0291

(57) ABSTRACT

A route guidance system, a route guidance method, and a mobile device are disclosed. In one embodiment, a route guidance system comprises a first mobile device and at least one second mobile device. The first mobile device stores a route to a destination and comprises a transmitter and at least one first processor. The at least one second mobile device acquires a device position of the at least one second mobile device itself. The at least one processor creates guidance information on the basis of the device position, the route, and the destination. The at least one processor also causes the transmitter to transmit route guidance to the at least one second mobile device on the basis of the guidance information.

### CROSS-REFERENCE TO RELATED APPLICATION

The present application is a continuation in part based on PCT Application No. PCT/JP2015/054853, filed on Feb. 20, 2015, which claims the benefit of Japanese Application No. 2014-031822, filed on Feb. 21, 2014. PCT Application No. PCT/JP2015/054853 is entitled “ROUTE GUIDANCE SYSTEM, ROUTE GUIDANCE PROGRAM, AND ROUTE GUIDANCE METHOD,” and Japanese Application No. 2014-031822 is entitled “ROUTE GUIDANCE SYSTEM, ROUTE GUIDANCE PROGRAM, AND ROUTE GUIDANCE METHOD.” The contents of which are incorporated by reference herein in their entirety.

### FIELD

Embodiments of the present disclosure relate to route guidance.

### BACKGROUND

Wearable apparatuses equipped with security buzzers and having the function of, for example, transmitting information on the whereabouts of children have been proposed with the aim of, for example, protecting children from crimes.

### SUMMARY

A route guidance system, a route guidance method, and a mobile device are disclosed. In one embodiment, a route guidance system comprises a first mobile device and at least one second mobile device. The first mobile device stores a route to a destination and comprises a transmitter and at least one first processor. The at least one second mobile device acquires a device position of the at least one second mobile device itself. The at least one first processor creates guidance information on the basis of the device position, the route, and the destination. The at least one processor also causes the transmitter to transmit route guidance to the at least one second mobile device on the basis of the guidance information.

In one embodiment, a route guidance method in a route guidance system comprises a creation step and a guidance step. The route guidance system includes a first mobile device that receives input of a route to a destination and at least one second mobile device that acquires a device position of the at least one second mobile device itself. In the creation step, guidance information is created on the basis of the device position, the route, and the destination. In the guidance step, route guidance is provided on the at least one second mobile device on the basis of the guidance information.

In one embodiment, a mobile device comprises a memory, a receiver, a transmitter, and at least one processor. The memory stores a route to a destination. The receiver receives a device position of another mobile device. The at least one processor creates guidance information on the basis of the device position, the route, and the destination. The at least one processor also causes the transmitter to transmit route guidance to the another mobile device on the basis of the guidance information.

### BRIEF DESCRIPTION OF THE DRAWINGS

FIG. 1 illustrates a diagram showing an example of a configuration of a route guidance system.

FIG. 2 illustrates an example of an external view of a mobile phone.

FIG. 3 illustrates an example of a front surface of a wearable terminal having a normal shape.

FIG. 4 illustrates an example of a rear surface of the wearable terminal having the normal shape.

FIG. 5 illustrates an example of a left side surface of the wearable terminal having the normal shape.

FIG. 6 illustrates an example of a right side surface of the wearable terminal having the normal shape.

FIG. 7 illustrates a front side of the wearable terminal having a fitted shape.

FIG. 8 illustrates a rear side of the wearable terminal having the fitted shape.

FIG. 9 illustrates a side surface of the wearable terminal having the fitted shape.

FIG. 10 illustrates another side surface of the wearable terminal having the fitted shape.

FIG. 11 illustrates an example of the state in which the wearable terminal is worn.

FIG. 12 illustrates an example of a cross section taken along the line VA-VA in FIG. 4.

FIG. 13 illustrates an example of a cross section taken along the line VB-VB in FIG. 9.

FIG. 14 illustrates a diagram showing an example of an electrical configuration of the mobile phone.

FIG. 15 illustrates a diagram showing an example of an electrical configuration of the wearable terminal.

FIG. 16 illustrates a diagram showing an example of the state in which a map is displayed on a display.

FIG. 17 illustrates the state in which a tap operation is performed on a terminal position icon.

FIG. 18 illustrates an example of the state in which a route is input.

FIG. 19 illustrates another example of the state in which the route is input.

FIG. 20 illustrates an example of the state in which the input route is confirmed.

FIG. 21 illustrates an example of the state in which route guidance is started.

FIG. 22 illustrates an example of the state in which the route guidance is provided.

FIG. 23 illustrates another example of the state in which the route guidance is provided.

FIG. 24 illustrates an example of the state in which the route guidance is ended.

FIG. 25 illustrates an example of an operation of changing the route.

FIG. 26 illustrates an example of the state in which the operation of changing the route is accepted.

FIG. 27 illustrates an example of the state in which a changed route is input.

FIG. 28 illustrates an example of the state in which input of the changed route is confirmed.

FIG. 29 illustrates an example of the state in which an operation of inputting a security alert zone is performed.

FIG. 30 illustrates an example of the security alert zone that has been input.

FIG. 31 illustrates an example of the state of the mobile phone and the state of the wearable terminal when a child approaches the security alert zone.

FIG. 32 illustrates an example of the state in which an operation of designating a location to be registered is performed.

FIG. 33 illustrates an example of a graphical user interface (GUI) for inputting location information.

FIG. 34 illustrates an example of the state of the mobile phone and the state of the wearable terminal when the child approaches a registered location.

FIG. 35 illustrates a diagram showing an example of a memory map of a random-access memory (RAM) of the mobile phone.

FIG. 36 illustrates a diagram showing an example of a memory map of a RAM of the wearable terminal.

FIG. 37 illustrates a flowchart showing an example of a terminal position information management processing performed by a processor of the mobile phone.

FIG. 38 illustrates a flowchart showing an example of a terminal management processing performed by the processor of the mobile phone.

FIG. 39 illustrates a flowchart showing an example of the terminal management processing performed by the processor of the mobile phone.

FIG. 40 illustrates a flowchart showing an example of a route guidance processing according to the first embodiment performed by the processor of the mobile phone.

FIG. 41 illustrates a flowchart showing an example of a registration processing performed by the processor of the mobile phone.

FIG. 42 illustrates a flowchart showing an example of a terminal position information transmission processing performed by a processor of the wearable terminal.

FIG. 43 illustrates a flowchart showing an example of a notification processing performed by the processor of the wearable terminal.

FIG. 44 illustrates the state in which a map including a first terminal position icon and a second terminal position icon is displayed.

FIG. 45 illustrates the state in which a tap operation is performed on the first terminal position icon.

FIG. 46 illustrates an example of an operation of inputting a route to a meeting point.

FIG. 47 illustrates an example of the state in which the meeting point is set.

FIG. 48 illustrates an example of the state in which route guidance on the route to the meeting point is performed.

FIG. 49 illustrates an example of the state in which the route guidance on the route to the meeting point is performed.

FIG. 50 illustrates an example of the state of the mobile phone and the states of the wearable terminals while the route guidance is provided in the route guidance system.

FIG. 51 illustrates a flowchart showing an example of the route guidance processing according to a second embodiment performed by the processor of the mobile phone.

FIG. 52 illustrates a flowchart showing an example of the route guidance processing according to the second embodiment performed by the processor of the mobile phone.

FIG. 53 illustrates a flowchart showing an example of the route guidance processing according to the second embodiment performed by the processor of the mobile phone.

### DETAILED DESCRIPTION

### First Embodiment

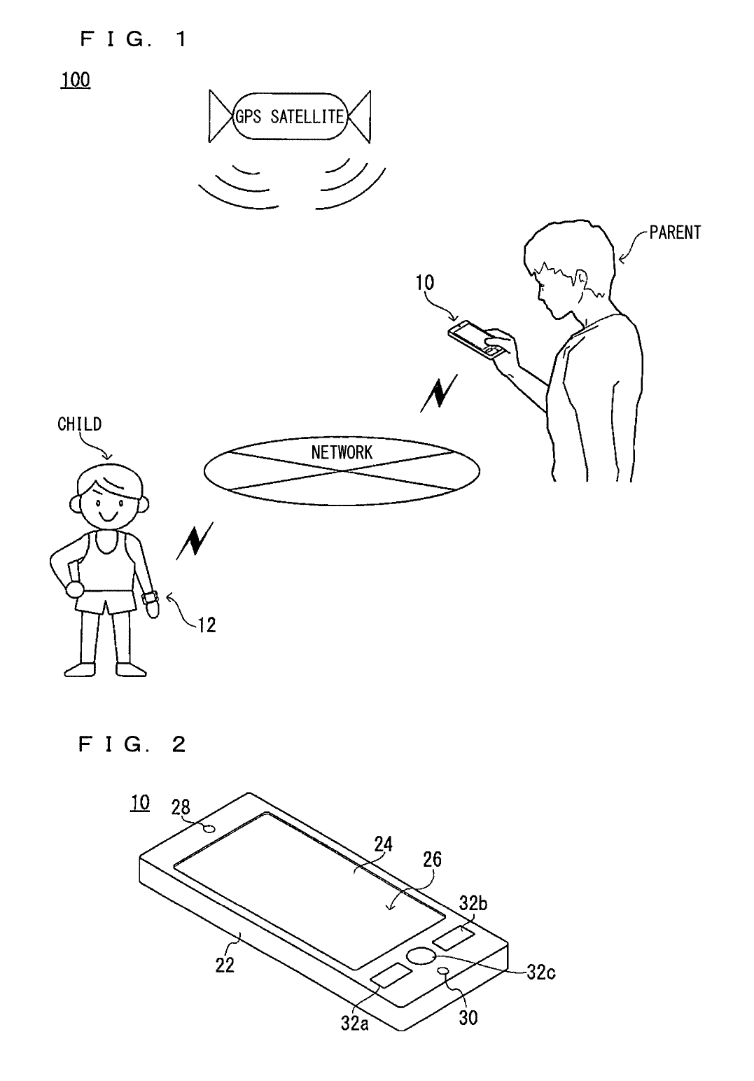

As illustrated in FIG. 1, a route guidance system 100 includes a mobile phone 10 and a wearable terminal 12. The mobile phone 10 and the wearable terminal 12 can individually determine their current positions upon receipt of global positioning system (GPS) signals from GPS satellites. The mobile phone 10 and the wearable terminal 12 can perform voice calls and data communications with each other through a network.

The route guidance system 100 can provide route guidance on the wearable terminal 12, using the data communications between the mobile phone 10 and the wearable terminal 12 through the network.

The mobile phone 10 is also referred to as a first mobile terminal. In one embodiment, the mobile phone 10 is a mobile terminal that can display a map, receive input of a route for the route guidance, and receive input of specific information, which will be described below. The mobile phone 10 can be designed to be carried by a parent, and thus may be also referred to as a parent-targeted mobile terminal.

The wearable terminal 12 is also referred to as a second mobile terminal. In one embodiment, the wearable terminal 12 can display an image for the above-mentioned route guidance and necessary information other than the image. The wearable terminal 12 can be designed to be worn by a child on his or her arm (body), and thus may be also referred to as a child-targeted mobile terminal.

The mobile phone 10 can perform various functions such as a voice call function, an e-mail function, a GPS function, a scheduling function, a text inputting and editing function, and a calculator function. Thus, the mobile phone 10 is also referred to as a high-functionality mobile terminal. Meanwhile, it may not be required that the wearable terminal 12 be capable of performing the functions including the voice call function, the e-mail function, the text inputting and editing function, and the calculator function. It may be only required that the wearable terminal 12 at least have the GPS function and the display function of displaying the above-mentioned image for the route guidance and the necessary information other than the image. Thus, the wearable terminal 12 may be also referred to as a low-functionality mobile terminal in contrast to the high-functionality mobile terminal mentioned above. In another embodiment, both the first mobile terminal and the second mobile terminal may be the mobile phones 10.

As illustrated in FIG. 2, the mobile phone 10 is, for example, a smartphone. The mobile phone 10 includes a housing 22 having a vertically-oriented flat rectangular shape, for example. The mobile phone 10 may be any mobile terminal such as a tablet terminal, a tablet personal computer (PC), a notebook PC, or a personal digital assistant (PDA).

On a main surface (front surface) of the housing 22 is located a display 24. The display 24 includes, for example, a liquid crystal panel or an organic electroluminescent (EL) panel. On the display 24 can be located a touch panel 26.

On the main surface of the housing, at one vertical end of the housing 22 is located a speaker 28. On the main surface of the housing, at another vertical end of the housing 22 is located a microphone 30.

On the main surface of the housing 22 are located a plurality of hard keys. Along with the touch panel 26, the plurality of hard keys are included in input operation means. In one embodiment, the plurality of hard keys include a call key 32a, a call end key 32b, and a menu key 32c.

In response to a touch operation performed on a dial pad displayed on the display 24, a telephone number is input to the mobile phone 10. Then, in response to an operation performed on the call key 32a, a voice call is started in the mobile phone 10. The voice call is ended in the mobile phone 10 in response to an operation performed on the call end key 32b. The power of the mobile phone 10 can be turned on or off in response to a long press on the call end key 32b.

In response to an operation on the menu key 32c, a home screen is displayed on the display 24. In this state, the parent can perform touch operations on, for example, an object displayed on the display 24 to select the object and confirm the selection. The touch panel 26 can detect the touch operations.

The mobile phone 10 can perform a map function of displaying a map including the current position, the e-mail function, and a browser function in addition to the telephone function. The graphical user interfaces (GUIs), such as keys, and icons displayed on the display 24 are also correctively referred to as objects in the following description.

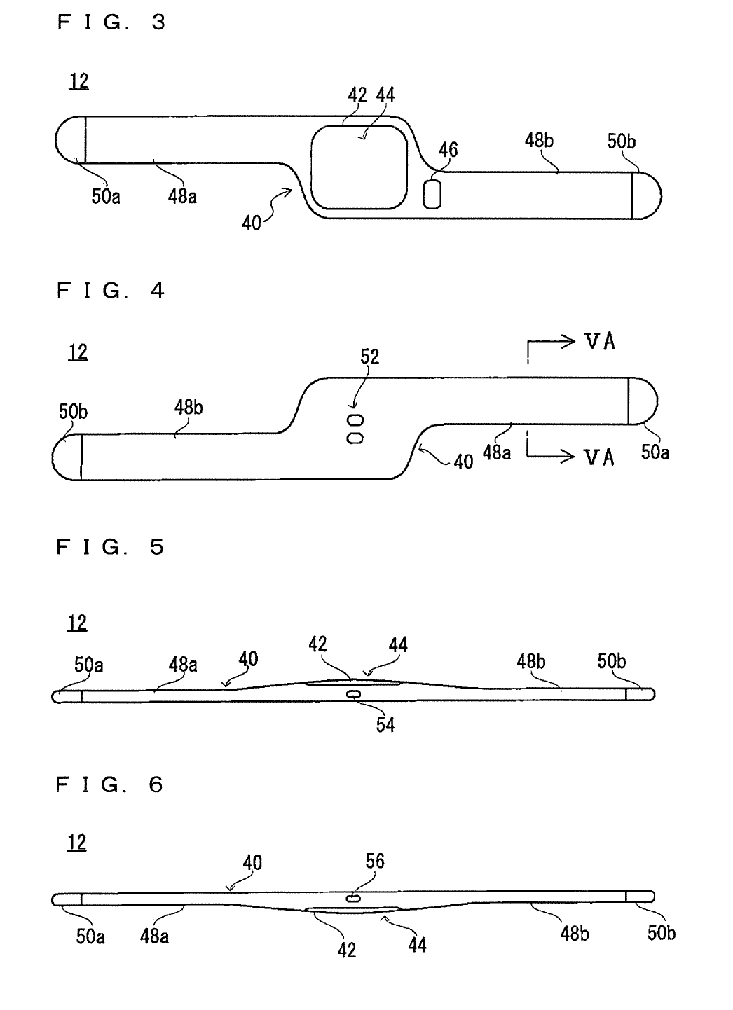

FIG. 3 illustrates a front surface of the wearable terminal 12 having a normal shape. FIG. 4 illustrates a rear surface of the wearable terminal 12 having the normal shape. FIG. 5 illustrates a left side surface of the wearable terminal 12 having the normal shape. FIG. 6 illustrates a right side surface of the wearable terminal 12 having the normal shape. The “normal shape” refers to the state in which a first belt 48a and a second belt 48b, which will be described below, are straight, not bent. When the wearable terminal 12 has the normal shape, the wearable terminal 12 is not worn by the user.

As illustrated in FIGS. 3 to 6, the wearable terminal 12 includes a case 40 made of silicon resin, for example. The wearable terminal 12 in one embodiment is, for example, IPX5/7 waterproof certified.

For example, the case 40 is a wristwatch-shaped case. On the approximately central part of the front surface of the case 40 is located a display 42. The display 42 includes, for example, a liquid crystal panel or an organic EL panel. On the display 42 is located a touch panel 44. Adjacent to the display 42 is located an input key 46.

The case 40 includes the first belt 48a and the second belt 48b with the display 42 therebetween. On the tips of the first belt 48a and the second belt 48b are located a first LED 50a and a second LED 50b, respectively. Each of the first LED 50a and the second LED 50b is also referred to as an “LED 50.”

On a rear surface of the case 40 is located a biosensor 52. On a left side surface of the case 40 is located a speaker 54. On a right side surface of the case 40 is located a microphone 56.

For example, the child (user) can make necessary settings on the wearable terminal 12 through the use of the GUIs displayed on the display 42 and perform a voice call accordingly while his or her arm is fitted with the wearable terminal 12. In a case where the child selects a call destination displayed on the wearable terminal 12, such as a telephone number assigned to the parent-targeted mobile terminal, a voice call is started in the wearable terminal 12. A hands-free voice call can be performed on the wearable terminal 12. Thus, the child can catch a voice output from the speaker 54 by moving the wearable terminal 12 close to his or her face. The child can input a voice to the microphone 56. When the child performs an operation on a call end GUI that is displayed on the display 42 during the voice call, the voice call is ended. The setting of the hands-free operation can be changed such that the child can perform a voice call without the need for moving the wearable terminal 12 close to his or her face.

The security buzzer function is performed in response to a long press on the input key 46. In a case where the security buzzer function is performed, the first LED 50a and the second LED 50b emit red light and the speaker 54 outputs a warning sound, for example. When the security buzzer function is performed, the wearable terminal 12 can determine the current position of the wearable terminal 12 itself and can send, together with the current position, a message that the security buzzer function is performed to the mobile phone 10. The current position determined by the wearable terminal 12 is also referred to as a terminal position.

The security buzzer function is automatically performed in the event of detection of the state in which the wearable terminal 12 is taken off from the child's arm. The wearable terminal 12 can determine that the wearable terminal 12 is taken off from the child's arm if the biosensor 52 fails to detect the biological information on the child (such as the child's pulse). The security buzzer function is not performed in the event of removal of the wearable terminal 12 while a removal mode is set. The removal mode may be set through the GUI displayed on the display 42 or may be set in accordance with a command signal from the mobile phone 10. With the wearable terminal 12 in the removal mode being taken off from the child's arm, the security buzzer function is performed in response to a long press on the input key 46, for example.

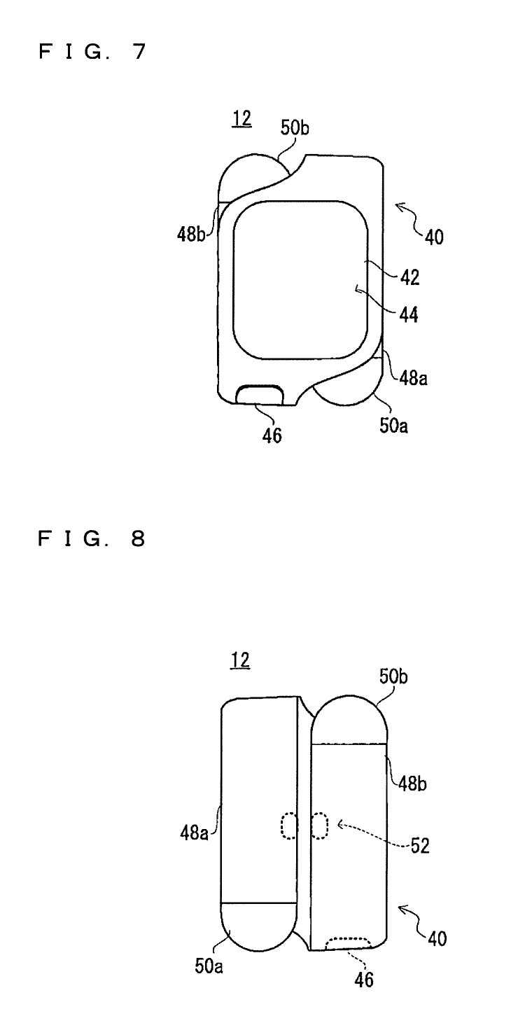

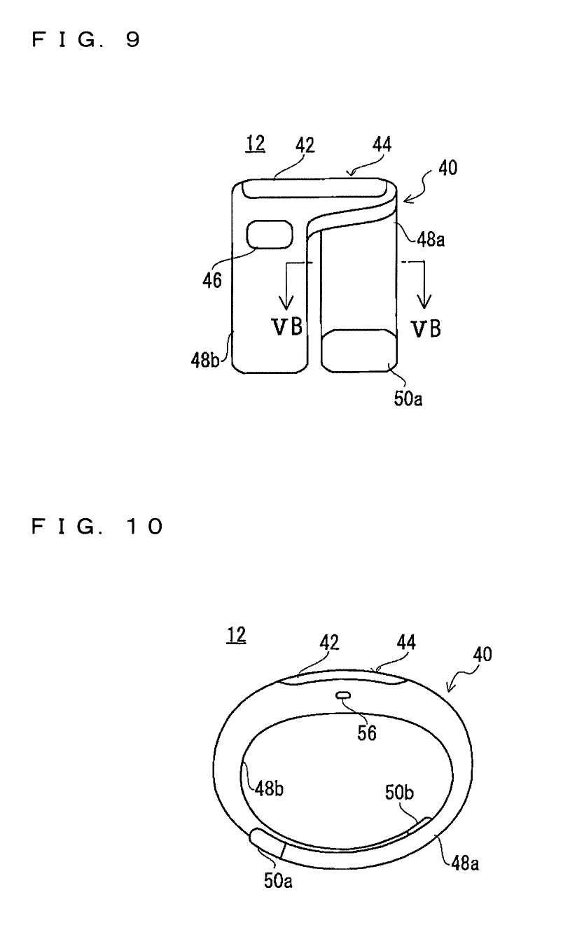

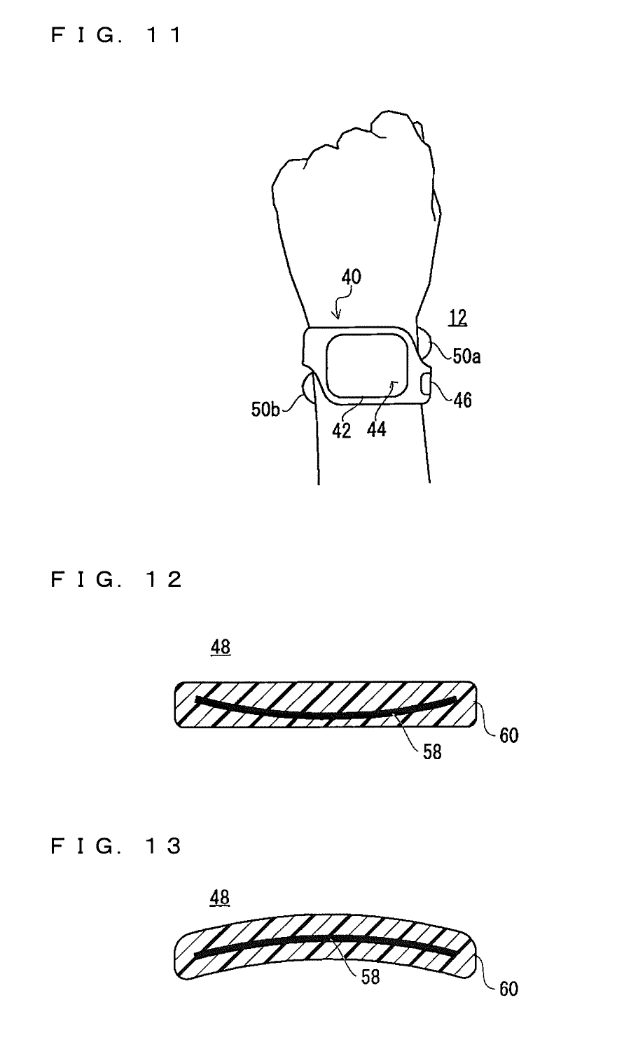

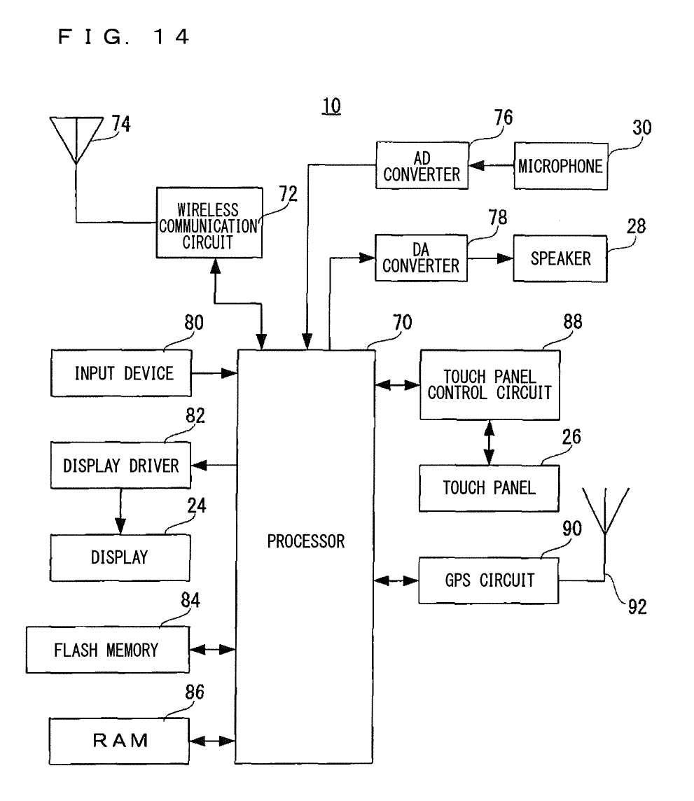

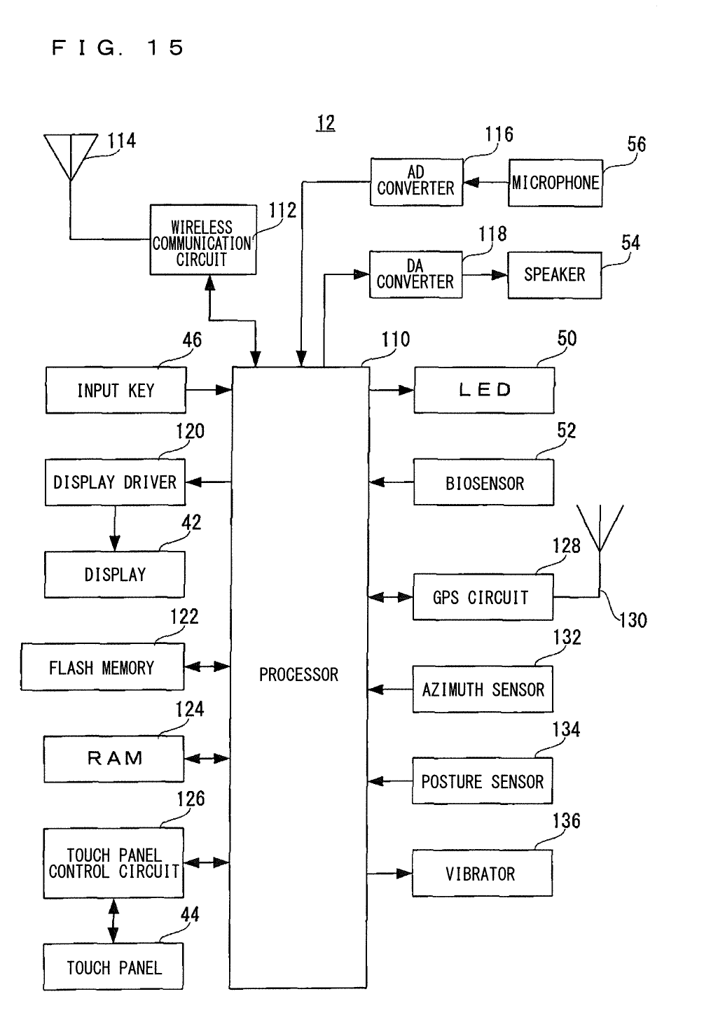

FIGS. 7 to 11 each illustrate an example of a shape (hereinafter referred to as a fitted shape) of the wearable terminal 12 in the state of being worn. FIG. 7 illustrates a front side of the wearable terminal 12 having the fitted shape. FIG. 8 illustrates a rear side of the wearable terminal 12 having the fitted shape. FIG. 9 illustrates a side surface of the wearable terminal 12 having the fitted shape. FIG. 10 illustrates another side surface of the wearable terminal 12 having the fitted shape. FIG. 11 illustrates an example of the state in which the wearable terminal 12 is worn.

As illustrated in FIGS. 7 to 10, the first belt 48a and the second belt 48b of the wearable terminal 12 having the fitted shape do not overlap each other and are bent to the rear side of the wearable terminal 12. The wearable terminal 12 has a ring shape when the wearable terminal 12 having the fitted shape is viewed from another side surface (see FIG. 10). In the state where the wearable terminal 12 is worn on an arm, the wearable terminal 12 having the ring shape is wrapped around the arm.

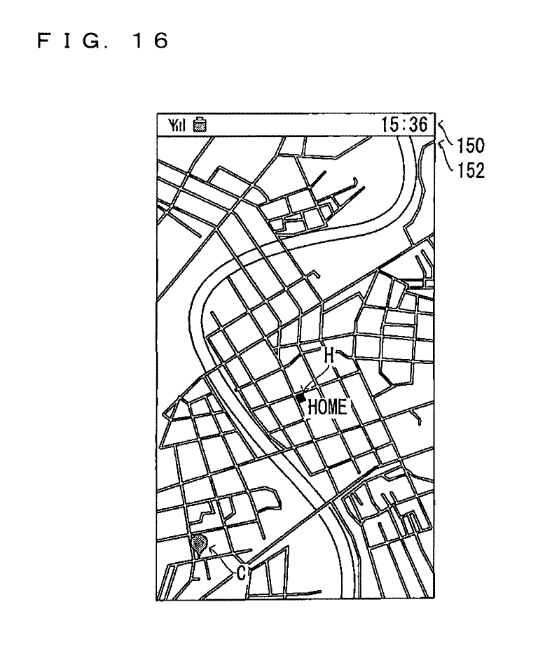

FIG. 12 illustrates a cross section of the wearable terminal 12 taken along the line VA-VA in FIG. 4. FIG. 13 illustrates a cross section of the wearable terminal 12 taken along the line VB-VB in FIG. 9. As illustrated in FIGS. 12 and 13, the first belt 48a and the second belt 48b include plates 58 made of metal and extending from approximately tip portions to the base portions of the respective belts. The plates 58 are surrounded by and covered with silicon resin 60. The first belt 48a and the second belt 48b can keep their respective normal shapes and fitted shapes owning to the plates 58, which are also called stainless steel spring wires.

In particular, as illustrated in FIG. 12, the cross section of the plate 58 is bent to the rear side of the case 40 in the normal shape. The plate 58 in this state as a whole keeps an approximately flat shape, and thus each of the first belt 48a and the second belt 48b can keep the normal shape illustrated in, for example, FIG. 4.

Meanwhile, as illustrated in FIG. 13, in the fitted shape, the central portion of the cross section of the plate 58 is bent to the front side of the case 40, or equivalently, in a direction opposite to the direction in FIG. 12. The plate 58 in this state keeps a shape bent to the inner side (the rear side of the case 40), and thus each of the first belt 48a and the second belt 48b can keep the fitted shape illustrated in, for example, FIG. 9.

When forces with which the plate 58 is bent to the rear side of the case 40 is exerted on the plate 58 in the state illustrated in FIG. 12, the plate 58 changes its shape as illustrated in FIG. 13. This means that the shape of the plate 58 is changed from an approximately flat shape to a curved shape. The shape of each of the first belt 48a and the second belt 48b is changed from the normal shape to the fitted shape accordingly. The plate 58 in the curved state has forces acting thereon to keep the curved state. Even if the first belt 48a and the second belt 48b each having the fitted shape are stretched toward the front side of the case 40, the plates 58 cause the respective belts to recover the shapes illustrated in FIG. 10. In a case where forces are exerted on the plate 58 in the state illustrated in FIG. 13 such that the plate 58 becomes approximately flat, the shape of the cross section of the plate 58 can be changed to the shape illustrated in FIG. 12.

Thus, the wearable terminal 12 can be worn by a child on his or her arm without the need for fastening together the first belt 48a and the second belt 48b each having the fitted shape. In particular, the curved plates 58 have forces acting thereon to keep their respective shapes, so that the wearable terminal 12 can be stably worn by a child on his or her arm regardless of the size of the arm. The case 40 may be made of the silicon resin 60 having a higher coefficient of friction. Once being worn on an arm, the wearable terminal 12 having this configuration is less likely to slip down from the arm. In another embodiment, the first belt 48a and the second belt 48b of the wearable terminal 12 may be fastened to each other through a mechanical component such as a fastening member. In still another embodiment, it is not required that the first belt 48a and the second belt 48b each having the fitted shape overlap each other, and further the tip of the first belt 48a and the tip of the second belt 48b may have a gap therebetween. This means that the wearable terminal 12 having the fitted shape in the still another embodiment has a ring shape as a whole, and particularly has a partially open ring shape.

As illustrated in FIG. 14, the mobile phone 10 in one embodiment illustrated in FIG. 1 or 2 includes, for example, a processor 70 called a computer or a central processing unit (CPU). The processor 70 is connected with, for example, a wireless communication circuit 72, an analog-to-digital (AD) converter 76, a digital-to-analog (DA) converter 78, an input device 80, a display driver 82, a flash memory 84, a random-access memory (RAM) 86, a touch panel control circuit 88, and a GPS circuit 90.

The processor 70 can perform overall control over the mobile phone 10. When coming into use, all or part of the program preset in the flash memory 84 is expanded in the RAM 86. The processor 70 can operate in accordance with the program in the RAM 86. The RAM 86 can be also used as a work area or a buffer area of the processor 70.

In accordance with various embodiments, the processor 70 may be implemented as a single integrated circuit (IC) or as multiple communicatively coupled ICs and/or discrete circuits. It is appreciated that the processor 70 can be implemented in accordance with various known technologies.

In one embodiment, the processor 70 includes one or more circuits or units configurable to perform one or more data computing procedures or processes by executing instructions stored in an associated memory, for example. In other embodiments, the processor 70 may be implemented as firmware (e.g. discrete logic components) configured to perform one or more data computing procedures or processes.

In accordance with various embodiments, the processor 70 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

The input device 80 includes the plurality of hard keys (such as the call key 32a) illustrated in FIG. 2. Thus, the input device 80 forms an operation acceptor that can accept key operations performed on the hard keys. The information (key dada) on the hard keys accepted by the operation acceptor is input to the processor 70.

The wireless communication circuit 72 is a circuit to transmit and receive, through an antenna 74, radio waves for voice calls and e-mails. In one embodiment, the wireless communication circuit 72 is a circuit to perform wireless communications based on the code division multiple access (CDMA) system. For example, in accordance with outgoing call (outgoing voice call) operation accepted by the touch panel 26, the wireless communication circuit 72 can execute, in accordance with the instructions from the processor 70, an outgoing voice call processing to output an outgoing voice call signal through the antenna 74. The outgoing voice call signal is transmitted to the telephone at the other end of the connection through the base station and the communication network. When the telephone at the other end of the connection performs an incoming voice call processing, the communicable state is established, and the processor 70 can execute a telephone communication processing accordingly.

The wireless communication circuit 72 is wirelessly connected with a network (such as a communication network or a telephone network) through the antenna 74. The mobile phone 10 can establish data communications with the wearable terminal 12 through the network accordingly.

The AD converter 76 is connected with the microphone 30 illustrated in FIG. 2. A voice signal from the microphone 30 is converted into digital voice data by the AD converter 76 and is input to the processor 70. The DA converter 78 is connected with the speaker 28. The DA converter 78 can convert the digital voice data into a voice signal and provide the voice signal to the speaker 28 through an amplifier. Thus, the speaker 28 can output a voice based on the voice data. During the execution of the telephone communication processing, voices collected by the microphone 30 are transmitted to the telephone at the other end of the connection and voices collected in the telephone at the other end of the connection are output from the speaker 28.

The display driver 82 is connected with the display 24 illustrated in FIG. 2. The display 24 can display a video or an image in accordance with video data or image data output from the processor 70. The display driver 82 includes a video memory that can temporarily store the image data displayed on the display 24. The video memory can store data output from the processor 70. The display driver 82 can cause the display 24 to display an image in accordance with the contents of the video memory. That is, the display driver 82 can control the display of the display 24 connected with the display driver 82 in accordance with the instructions from the processor 70. Thus, the processor 70 is also referred to as a display controller. The display 24 may include a backlight. The display driver 82 can control the brightness and turning on and off of the backlight in accordance with the instructions from the processor 70.

The touch panel control circuit 88 is connected with the touch panel 26. The touch panel control circuit 88 can supply the touch panel 26 with, for example, a needed voltage. The touch panel control circuit 88 can input, to the processor 70, a touch start signal indicating the start of a touch on the touch panel 26, an end signal indicating the end of the touch, and coordinate data indicating a touch position being the target position of the touch. The processor 70 can determine, on the basis of the coordinate data, which object is touched.

In one embodiment, the touch panel 26 is a capacitive touch panel that can detect changes in capacitance generated between the surface of the touch panel 26 and an object such as a finger (hereinafter referred to as a “finger” for convenience). The touch panel 26 can detect that the touch panel 26 is touched by, for example, one finger or a plurality of fingers. Thus, the touch panel 26 is also referred to as a pointing device. The touch panel control circuit 88 can output, to the processor 70, the coordinate data indicating the position of the touch operation within the touch valid range of the touch panel 26. When a touch operation is performed on the surface of the touch panel 26, the position of the operation, the direction of the operation, and the like are input to the mobile phone 10.

The mobile phone 10 may include a non-transitory recording medium that can be read by the processor 70 other than the flash memory 84 and the RAM 86. The mobile phone 10 may include, for example, a hard disk drive, a solid state drive (SSD), and a universal serial bus (USB) memory. Examples of touch operations according to one embodiment include a tap operation, a long tap operation, a flick operation, and a slide operation.

The tap operation refers to an operation of bringing a finger into contact (touch) with the surface of the touch panel 26 and then moving (releasing) the finger off the surface of the touch panel 26 in a short period of time. The long tap operation refers to an operation of keeping a finger in contact with the surface of the touch panel 26 for a period equal to or greater than a predetermined period and then moving the finger off the surface of the touch panel 26. The flick operation refers to an operation of bringing a finger into contact with the surface of the touch panel 26 and then causing the finger to flip in a desired direction at a speed equal to or greater than a predetermined speed. The slide operation refers to an operation of moving a finger in a desired direction while keeping the finger in contact with the surface of the touch panel 26 and then moving the finger off the surface of the touch panel 26.

The above-mentioned slide operation includes the so-called drag operation, which is a slide operation of bringing a finger into contact with an object displayed on the surface of the display 24 and moving the object. The operation of moving a finger off the surface of the touch panel 26 after the drag operation is referred to as a drop operation.

The word “operation” may be hereinafter omitted from the phrases including the tap operation, the long tap operation, the flick operation, the slide operation, the drag operation, and the drop operation. It is not required that the touch operation be performed with a finger of the user. Alternatively, the touch operation may be performed with, for example, a stylus pen.

The GPS circuit 90 is activated in determining the current position. Upon receipt of input of a GPS satellite signal received by a GPS antenna 92, the GPS circuit 90 can execute a positioning processing in accordance with the GPS signal. The GPS circuit 90 can compute the longitude, the latitude, and the altitude (elevation) as GPS information (position information) accordingly.

Although FIG. 1 illustrates a single GPS satellite for simplicity, the three-dimensional positioning associated with the current position requires GPS signals received from four or more GPS satellites. As long as GPS signals from three GPS satellites, instead of GPS signals from four or more GPS satellites, are received, the longitude and the latitude can be computed through the two-dimensional positioning.

The RAM 86 can store map data and the mobile phone 10 can display a map corresponding to the current position on the basis of the GPS information computed by the GPS circuit 90.

With reference to FIG. 15, the wearable terminal 12 according to one embodiment illustrated in FIG. 1 includes a processor 110 called a computer or a CPU. The processor 110 is connected with, for example, the input key 46, the LEDs 50, the biosensor 52, a wireless communication circuit 112, an AD converter 116, a DA converter 118, a display driver 120, a flash memory 122, a RAM 124, a touch panel control circuit 126, a GPS circuit 128, an azimuth sensor 132, a posture sensor 134, and a vibrator 136. The wireless communication circuit 112 is connected with an antenna 114. The display driver 120 is connected with the display 42. The touch panel control circuit 126 is connected with the touch panel 44. The GPS circuit 128 is connected with a GPS antenna 130. The AD converter 116, the DA converter 118, the display driver 120, the flash memory 122, the RAM 124, the touch panel control circuit 126, and the GPS circuit 128 are substantially the same as the corresponding components of the mobile phone 10, and thus the same description will not be repeated for simplicity.

The processor 110 can perform overall control over the wearable terminal 12 to perform functions including the voice call function, the security buzzer function, and the data communication function. The information (key data) on the hard keys accepted by the input key 46 is input to the processor 110.

In accordance with various embodiments, the processor 110 may be implemented as a single integrated circuit (IC) or as multiple communicatively coupled ICs and/or discrete circuits. It is appreciated that the processor 110 can be implemented in accordance with various known technologies.

In one embodiment, the processor 110 includes one or more circuits or units configurable to perform one or more data computing procedures or processes by executing instructions stored in an associated memory, for example. In other embodiments, the processor 110 may be implemented as firmware (e.g. discrete logic components) configured to perform one or more data computing procedures or processes.

In accordance with various embodiments, the processor 110 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

The wireless communication circuit 112, which is substantially the same as the wireless communication circuit 72 of the mobile phone 10, can perform wireless communications based on the CDMA system. For example, when an operation of selecting a telephone number directory entry is performed on the wearable terminal 12, the wireless communication circuit 112 can execute, in accordance with the instructions from the processor 110, the outgoing voice call processing to output an outgoing voice call signal through the antenna 114. The outgoing voice call signal is transmitted to, for example, the mobile phone 10 through the base station and the communication network. For example, when the incoming voice call processing is performed in the mobile phone 10, the communicable state in which the wearable terminal 12 can communicate with the mobile phone 10 is established, and then the processor 110 executes the voice call processing. In this state, the child can communicate with the parent through the speaker 54 and the microphone 56.

When the antenna 114 receives an outgoing voice call signal transmitted by the mobile phone 10, the wireless communication circuit 112 can notify the processor 110 of an incoming call, and then the processor 110 can execute the incoming call processing accordingly. For example, when the incoming call processing is executed, the speaker 54 outputs ringtones and the vibrator 136, which will be described below, causes the wearable terminal 12 to vibrate. When the incoming voice call operation is performed on the wearable terminal 12, the communicable state in which the wearable terminal 12 can communicate with, for example, the mobile phone 10 is established, and then the processor 110 executes the voice call processing.

The display 42 displays GUIs for operating the wearable terminal 12. The GUIs are operated through the touch panel 44. For example, with the GUI for performing an outgoing call operation being displayed, when the child performs an outgoing call operation using the touch panel 44, an outgoing voice call signal is output as described above.

The LEDs 50 can emit light in a plurality of colors, such as red, blue, and green. The processor 110 controls, for example, the color of emission light and the cycle of flashing. As described above, the LEDs 50 emit red light when the security buzzer function is performed.

The biosensor 52 is a sensor for measuring a pulse of a person (child). As described above, the processor 110 determines, through the use of the output from the biosensor 52, whether the wearable terminal 12 is worn by the child. While the biosensor 52 measures the child's pulse, the processor 110 determines that the wearable terminal 12 is worn by the child. While the biosensor 52 does not measure the child's pulse, the processor 110 determines that the wearable terminal 12 is not worn by the child.

The azimuth sensor 132, which is also referred to as an electromagnetic compass or a direction output unit, includes three geomagnetic sensors and a control circuit. The control circuit extracts geomagnetic data from magnetic data detected by the three geomagnetic sensors, and then outputs the geomagnetic data to the processor 110. The processor 110 computes the azimuth angle (azimuth or direction) data with reference to geomagnetic data output from the control circuit and causes the buffer of the RAM 124 to store the data as the direction of the wearable terminal 12. In one embodiment, the azimuth is given in degrees counting clockwise, with 0 degrees at north (N), 90 degrees at east (E), 180 degrees at south (S), and 270 degrees at west (W). Each geomagnetic sensor includes a hall element. Alternatively, each geomagnetic sensor may include a magnet-resistive (MR) element or a magnet-impedance (MI) element.

The posture sensor 134 is used to detect the movement of the wearable terminal 12. The posture sensor 134 is, for example, a piezoelectric gyroscope. The piezoelectric gyroscope can detect angular velocities around three axes (X, Y, and Z axes) and output the detection results to the processor 110. The processor 110 detects the movement and the inclination of the wearable terminal 12 on the basis of the angular velocities around the individual axes detected by the posture sensor 134.

For example, the processor 110 determines, in accordance with the posture detected by the posture sensor 134, whether the child is checking the wearable terminal 12. While the child is checking the wearable terminal 12, the processor 110 detects, by using the azimuth sensor 132, the azimuth the child faces, namely, the heading direction of the child. The wearable terminal 12 transmits, to the mobile phone 10, terminal position information including the current position (terminal position), the posture, and the azimuth.

The vibrator 136 is a motor including an eccentric load mounted on the rotation axis. The turning on and off of the vibrator 136 is controlled by the processor 110. When the vibrator 136 is activated (turned on), vibrations of the vibrator 136 cause the wearable terminal 12 to vibrate.

The wearable terminal 12 may include a non-transitory recording medium that can be read by the processor 110 other than the flash memory 122 and the RAM 124. The wearable terminal 12 may include, for example, a hard disk drive, an SSD, and a USB memory.

FIG. 16 illustrates an example of a map displayed by the display 24 of the mobile phone 10. As illustrated in FIG. 16, the display range of the display 24 includes a state display area 150 and a function display area 152. In the state display area 150 are displayed a pictogram indicating the radio wave reception condition at the antenna 74, a pictogram indicating the remaining battery life of the secondary battery, and a time of day. In the function display area 152 is displayed a map. On the map are displayed a home position icon H indicating a registered home position (hereinafter referred to as a “home position”) and a terminal position icon C indicating the terminal position received from the wearable terminal 12. For example, when the parent causes the mobile phone 10 to perform the function (hereinafter referred to as a “management function”) of managing the wearable terminal 12, map data including the home position and the current position of the child (the terminal position of the wearable terminal 12) is read from the RAM 86, and then a map including the above-mentioned information is displayed on the display 24.

With the map being displayed, when a route to home (destination) is input to the mobile phone 10 (parent-targeted mobile terminal), the route guidance is provided on the wearable terminal 12 (child-targeted mobile terminal).

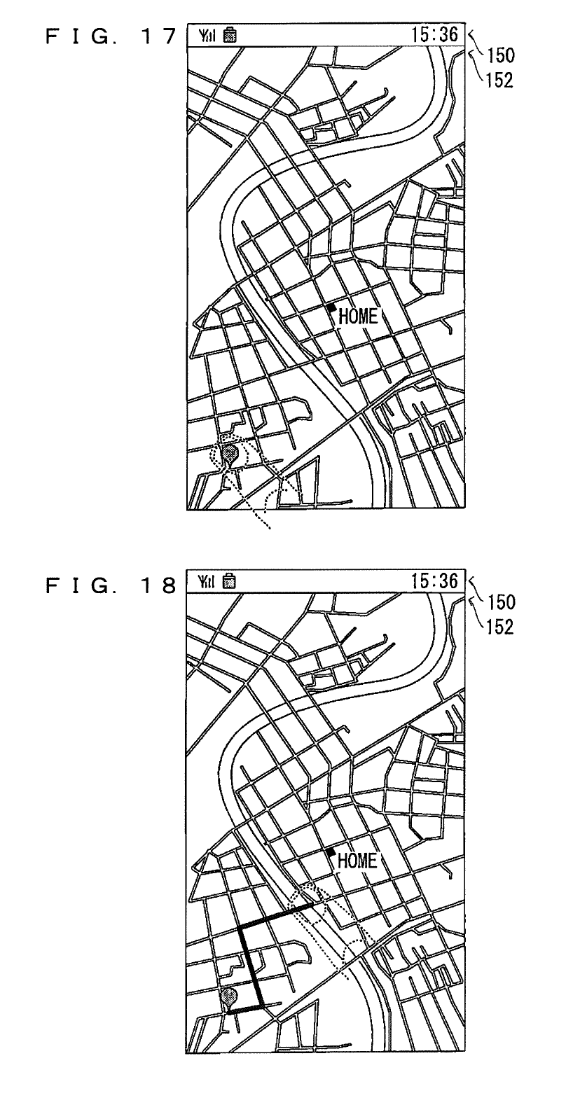

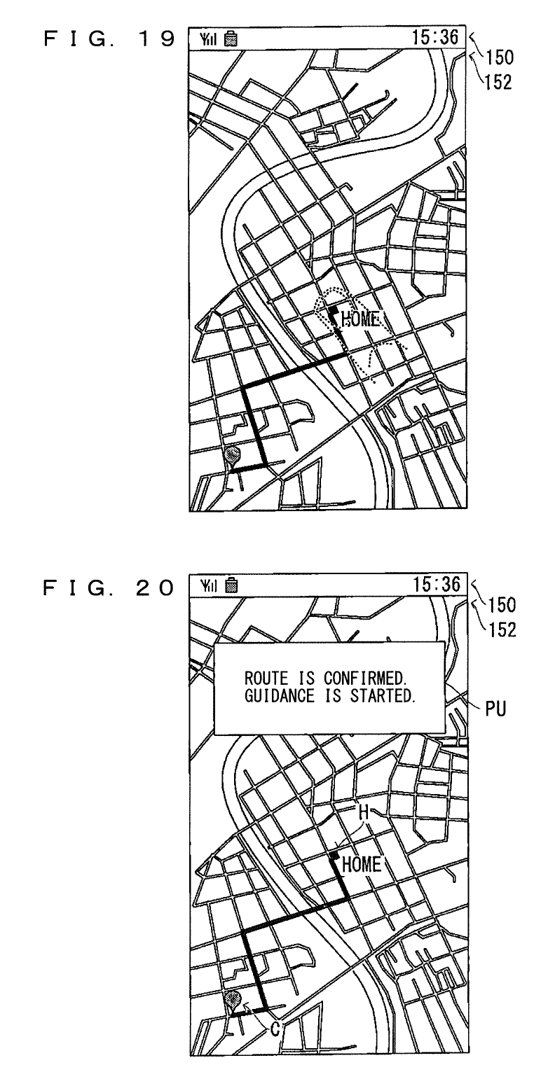

With reference to FIGS. 17 to 20, description will be given on an operation of inputting a route. As illustrated in FIG. 17, when the parent performs a tap on the terminal position icon C indicating the position of the wearable terminal 12, the mobile phone 10 becomes ready to receive input of a route. The parent performs a slide to input a route from the terminal position icon C to the home position icon H in this state as illustrated in FIG. 18, and then performs a tap operation on the home position icon H as illustrated in FIG. 19 to complete the inputting of the route to the mobile phone 10. When the parent completes the inputting of the route to the mobile phone 10, the display 24 displays, as illustrated in FIG. 20, a pop-up PU conveying a message that the input route is confirmed and that the route guidance associated with the route is started. At this time, the mobile phone 10 creates guidance information including a message that the route guidance is provided. When the guidance information is transmitted to the wearable terminal 12, the display 42 displays the message that the route guidance is provided. The wearable terminal 12 activates the vibrator 136.

After a certain period of time with no input operation being performed on the mobile phone 10 in the state of being ready to receive input of a route, this state of being ready to receive input of a route is released (canceled).

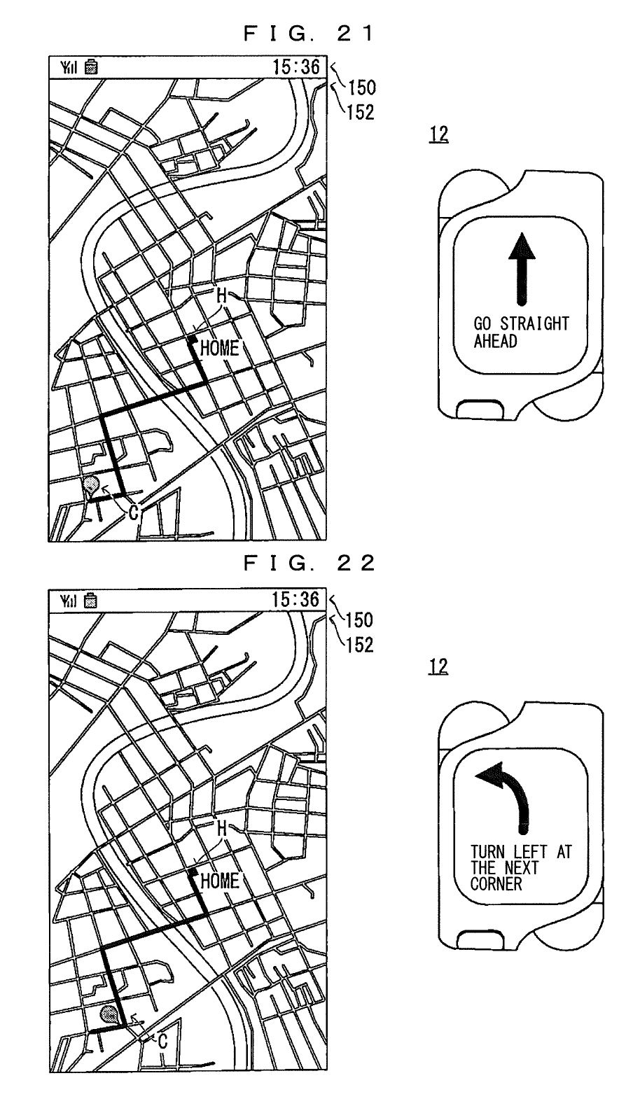

With reference to FIGS. 21 to 24, description will be given on actions during the route guidance. Firstly, the mobile phone 10 reads the terminal position and the azimuth (the orientation of the child) from the terminal position information transmitted from the wearable terminal 12, and creates guidance information indicating which direction the child should head into. If the orientation of the child agrees with the heading direction of the child on the route, the guidance information including a message and an icon for advising the child to keep going is created. When the wearable terminal 12 receives the guidance information, the display 42 of the wearable terminal 12 displays the message and the icon for advising the child to keep going (see FIG. 21).

Then, guidance information is created in the mobile phone 10 every time the terminal position information is changed. The created guidance information is transmitted to the wearable terminal 12. As illustrated in FIG. 22, the position of the terminal position icon C on the display 24 of the mobile phone 10 is updated corresponding to the child's position that has changed in accordance with, for example, the route guidance. When the child wearing the wearable terminal 12 approaches a branch point, such as an intersection, the mobile phone 10 creates the guidance information indicating the path the child should follow. In a case where the path turns left with respect to the orientation of the child, guidance information including a message advising the child to turn left at the branch point and an icon indicating the left is created. The display 42 of the wearable terminal 12 that has received the guidance information displays the message advising the child to turn left with respect to the heading direction of the child and the icon indicating the left (see FIG. 22).

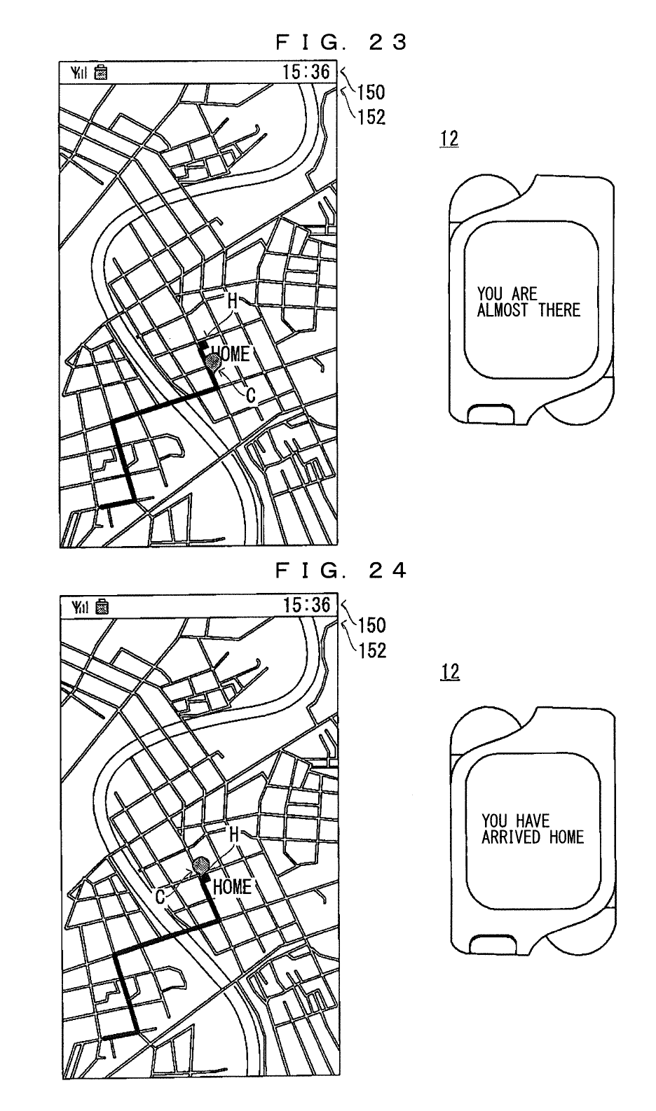

As illustrated in FIG. 23, in a case where the terminal position of the wearable terminal 12 moves close to the home position, the guidance information notifying that the child is in close proximity to home is created. When the wearable terminal 12 receives the guidance information, the display 42 of the wearable terminal 12 displays a message that the child is in close proximity to home.

As illustrated in FIG. 24, when the mobile phone 10 determines that the wearable terminal 12 (the child) has arrived home on the basis of the terminal position and the home position, the mobile phone 10 transmits, to the wearable terminal 12, arrival information notifying that the child has arrived home. When the wearable terminal 12 receives the arrival information, the display 42 of the wearable terminal 12 displays a message that the child has arrived home.

As described above, the appropriate route guidance can be easily provided in accordance with the position of the child. The child can head toward the destination by following the route guidance.

In another embodiment, the speaker 54 may output the contents of the guidance information during the route guidance. In still another embodiment, the route guidance may be provided by voices output from the speaker 54 with no use of the display on the display 42.

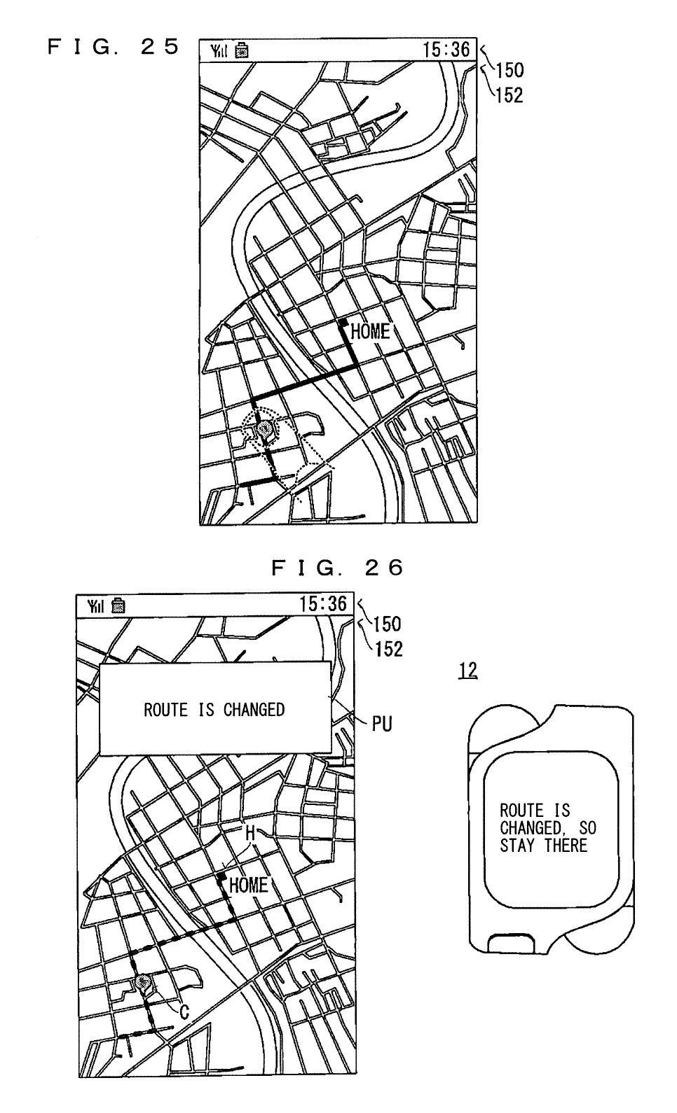

Next, description will be given on a route change with reference to FIGS. 25 to 28. As illustrated in FIG. 25, in response to a tap performed on the terminal position icon C during the route guidance, the mobile phone 10 transfers to the state of being ready to accept an operation of changing the route. When the mobile phone 10 is transferred to the state, the display 24 displays, as illustrated in FIG. 26, the pop-up PU including a message that the route can be changed. The display state of the route is changed accordingly. The mobile phone 10 transmits, to the wearable terminal 12, temporary halt information notifying that the route guidance is temporality halted. The display 42 of the wearable terminal 12 that has received the information displays a message that the route guidance is temporarily halted and that the child should stay at the current position. This can prevent the child from straying from the route during the route change.

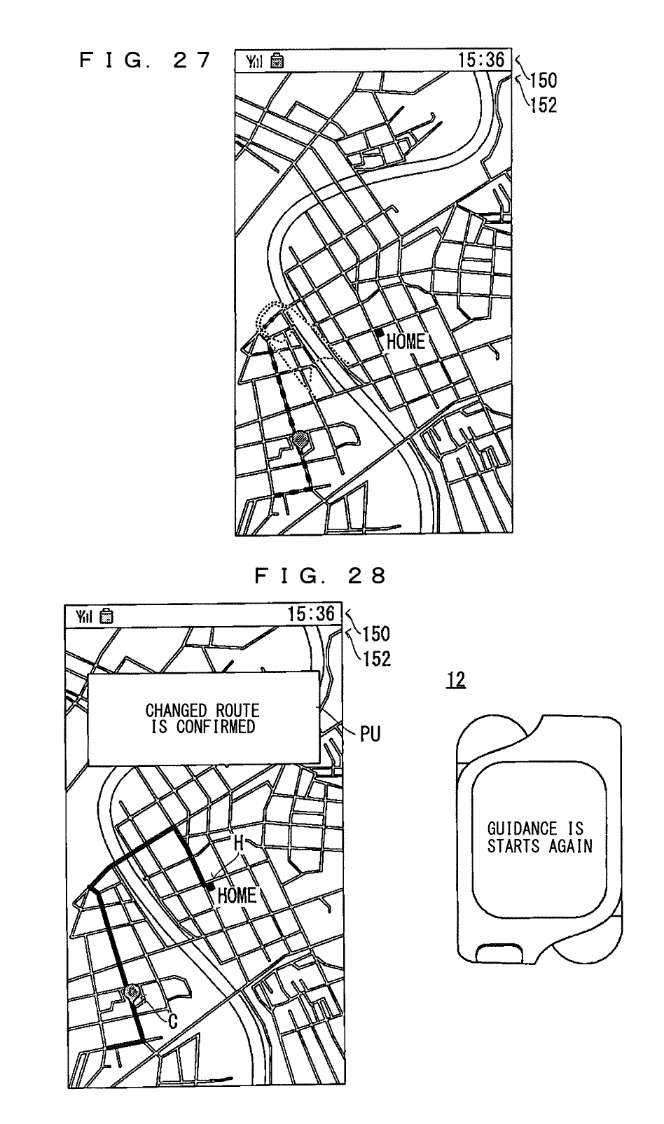

As illustrated in FIG. 27, in a case where the parent performs a slide operation starting from the terminal position icon C, the mobile phone 10 accepts, as a changed route, the route input in response to the slide operation. In a case where a slide operation is performed to reach the home position icon H and then a tap operation is performed on the home position icon H, the changed route is confirmed. At this time, the display 24 of the mobile phone 10 displays, as illustrated in FIG. 28, the pop-up PU including a message that the input of the changed route is confirmed. The mobile phone 10 creates resumption information notifying that the route guidance is resumed, and then transmits the resumption information to the wearable terminal 12. The display 42 of the wearable terminal 12 that has received the information displays a message that the route guidance is resumed. Consequently, the child can be notified of the resumption of the route guidance that has been temporarily halted.

As described above, the route can be changed during the route guidance. This configuration allows the parent to promptly handle any problem associated with the initially input route. Assuming that the mobile phone 10 is capable of receiving information on accidents, the parent can check the information on an accident using the mobile phone 10. In the event of an accident in the area around the route, the parent can change the route on the basis of the information on the accident. The route can be changed in real time, and this configuration allows the parent to ensure safety of the child by changing the route in the event of an unexpected incident.

In one embodiment, besides the route guidance, specific places such as a security alert zone and a security alert location can be registered, and a notification of specific information can be provided if the child approaches the relevant place.

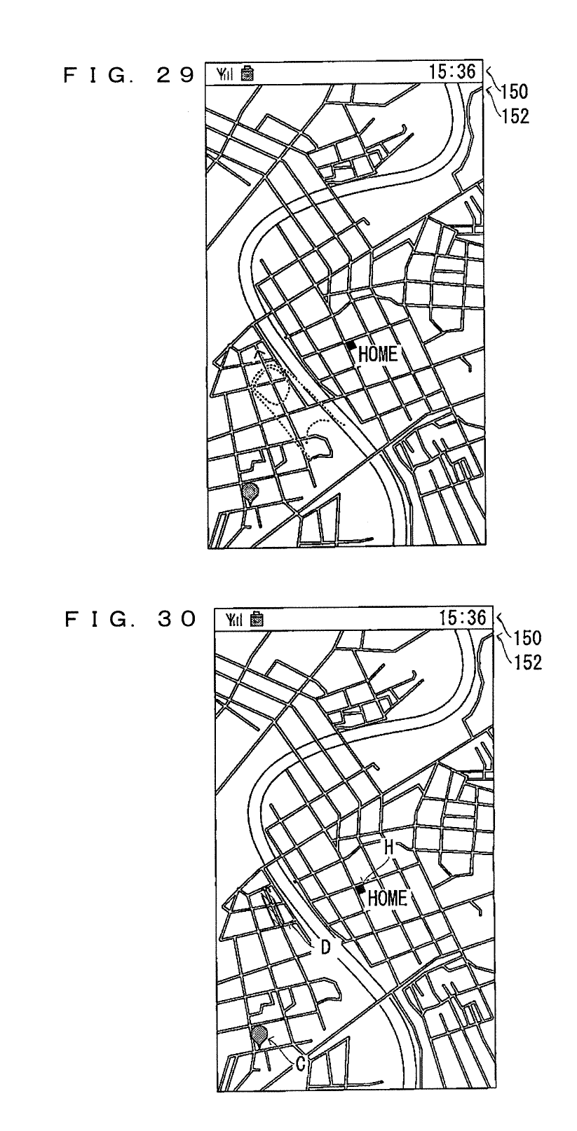

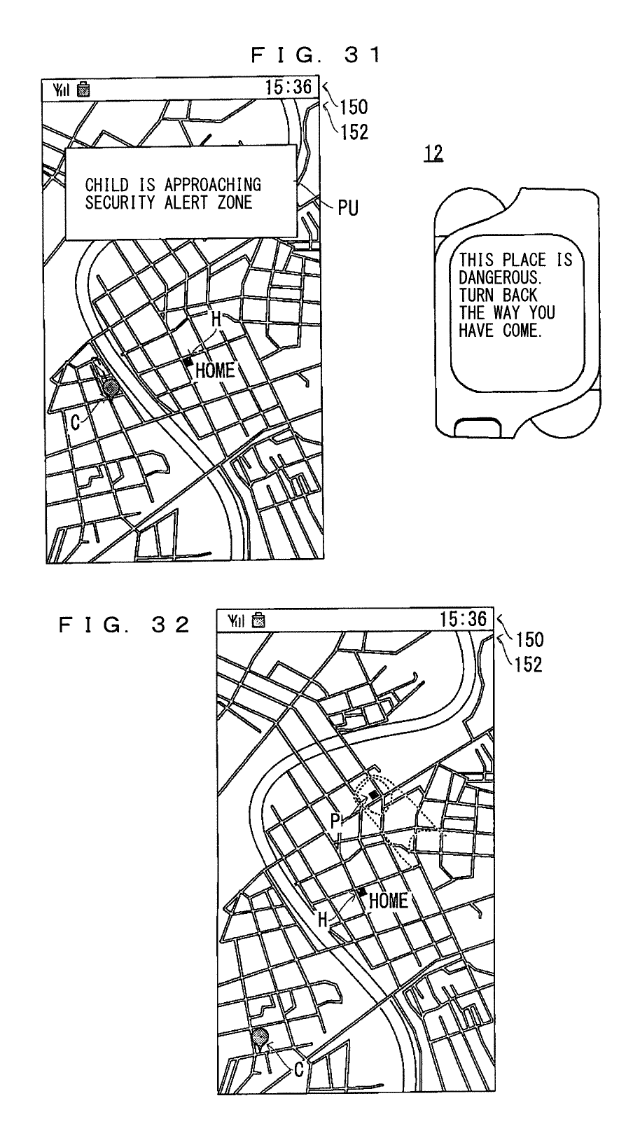

As illustrated in FIGS. 29 and 30, with a map being displayed on the display 24, a security alert zone D is input in accordance with a slide operation performed by the parent on a zone on the map. When the terminal position icon C moves close to the security alert zone D input in such a manner, the display 24 of the mobile phone 10 displays, as illustrated in FIG. 31, the pop-up PU notifying that the child (the wearable terminal 12) is approaching the security alert zone D. The mobile phone 10 transmits, to the wearable terminal 12, warning information advising the child to move away from the security alert zone D. The display 42 of the wearable terminal 12 displays a message advising the child to move away from the security alert zone D.

Thus, the parent can register a dangerous place, such as a road with a lot of traffic or an area close to a river, as the security alert zone D in advance. If the child approaches the security alert zone D, the child can be given a warning.

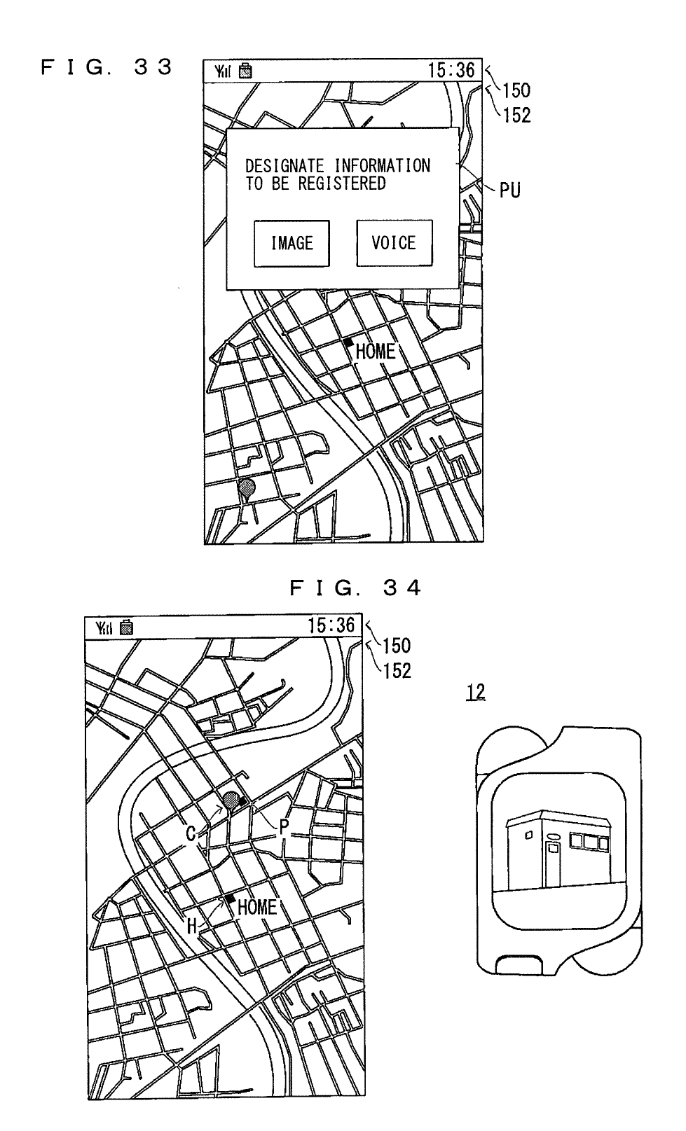

As illustrated in FIG. 32, with a map being displayed on the display 24, the parent can perform a tap operation on a location (hereinafter referred to as a registered location) P to register the registered location P and location information indicating the state of the area around the registered location P. In one embodiment, as illustrated in FIG. 33, an image or a voice can be input as the location information. With an image of the area around the registered location P being registered as the location information, when the wearable terminal 12 (the child) approaches the registered location P, the mobile phone 10 transmits, to the wearable terminal 12, the location information (the image) corresponding to the registered location P. Then, as illustrated in FIG. 34, the display 42 of the wearable terminal 12 displays the image transmitted as the location information.

Thus, the parent can register, in advance, the location information associated with the place the child may step in. When approaching the registered location, the child can check the state of the surrounding area. With the information on the area around a store being registered as the location information, the child going on an errand for the parent can check the information of the area around the store on the wearable terminal 12 when approaching the store.

As described above, if various places are registered in advance, the child can be given information at an appropriate timing.

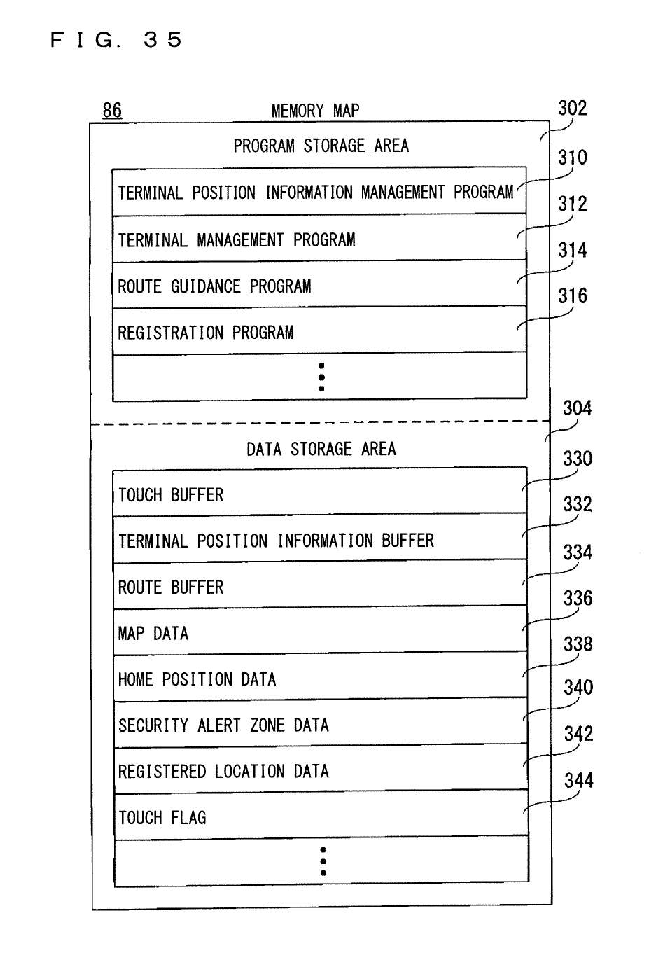

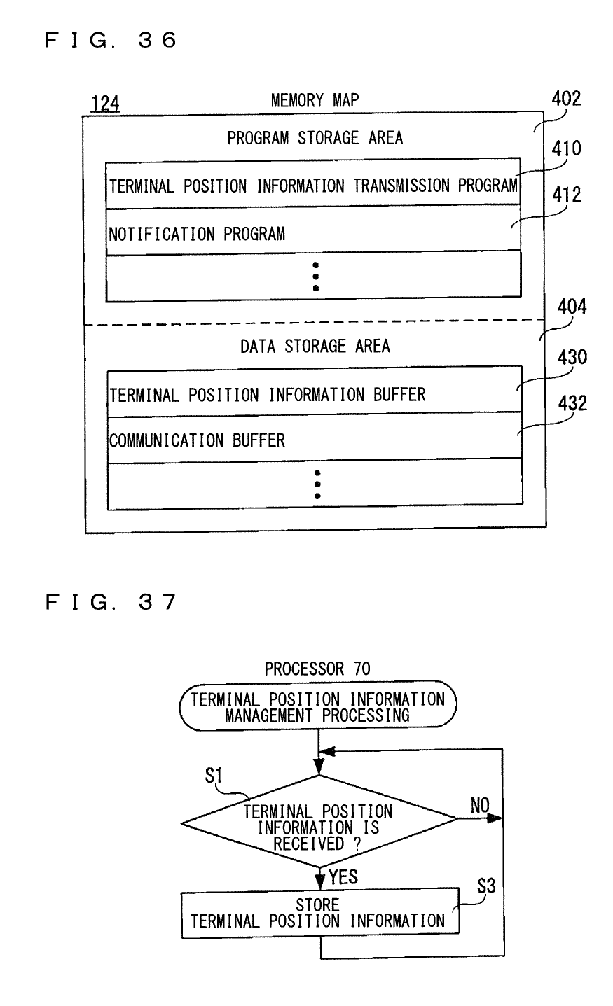

The above description has provided an overview of the features of the first embodiment. The features will be described below in detail with reference to the memory map of the RAM 86 of the mobile phone 10 in FIG. 35, the memory map of the RAM 124 of the wearable terminal 12 in FIG. 36, and flowcharts in FIGS. 37 to 43.

With reference to FIG. 35, the RAM 86 of the mobile phone 10 includes a program storage area 302 and a data storage area 304 formed therein. As described above, the program storage area 302 is an area for reading and storing (expanding) all or part of the program data preset in the flash memory 84 (see FIG. 14).

In the program storage area 302 are stored a terminal position information management program 310 for receiving and storing the terminal position information transmitted by the wearable terminal 12, a terminal management program 312 for controlling the route guidance and registering a given piece of information, a route guidance program 314 for providing the route guidance on the wearable terminal 12, a registration program 316 for registering a designated insecurity area, a location to be registered, and location information, and the like. Furthermore, a program for performing the functions, such as the e-mail function and the browser function, is also stored in the program storage area 302.

In the data storage area 304 of the RAM 86 are provided a touch buffer 330, a terminal position information buffer 332, a route buffer 334, and the like. Furthermore, map data 336, home position data 338, security alert zone data 340, registered location data 342, and the like are stored in the data storage area 304. A touch flag 344 and the like are also provided in the data storage area 304.

In the touch buffer 330, data including the data on touch coordinates output by the touch panel control circuit 88 and the data on touch coordinates of the starting point and the endpoint of a touch operation is temporarily stored. The received terminal position information is temporarily stored in the terminal position information buffer 332. The input route is temporarily stored in the route buffer 334.

The map data 336 is the data on a map displayed during the route guidance and the registration of information. The home position data 338 is the data indicating the position of the registered home. The security alert zone data 340 is the data indicating the security alert zone D illustrated in, for example FIG. 30. The registered location data 342 is the data including the registered location P illustrated in, for example, FIG. 32 and the location information input with respect to the registered location P.

The touch flag 344 is the flag for determining whether the touch panel 26 is touched. The touch flag 344 includes, for example, a 1-bit register. If the touch flag 344 is on (set), the data value “1” is placed in the register. If the touch flag 344 is turned off (cleared), the data value “0” is placed in the register. The touch flag 344 is toggled on and off in accordance with the output from the touch panel control circuit 88.

In the data storage area 304, the data for displaying an object such as a GUI is stored, and another flag and a timer (counter) required in execution of the programs are provided.

With reference to FIG. 36, the RAM 124 of the wearable terminal 12 includes a program storage area 402 and a data storage area 404 formed therein. Similarly to the program storage area of the mobile phone 10, the program storage area 402 is the area for storing (expanding) all or part of the program data preset in the flash memory 122 (see FIG. 15).

In the program storage area 402 are stored a terminal position information transmission program 410 for transmitting the terminal position information to the mobile phone 10 and a notification program 412 for providing a notification of information transmitted from the mobile phone 10. Furthermore, programs for performing functions, such as the voice call function and the security buzzer function, are also stored in the program storage area 402.

In the data storage area 404 of the RAM 124 are provided a terminal position information buffer 430, a communication buffer 432, and the like.

In the terminal position information buffer 430, the terminal position information including the current position determined by the wearable terminal 12, the posture of the wearable terminal 12, and the detected azimuth is temporarily stored. The communication buffer 432 is the buffer in which information received from the mobile phone 10 including the guidance information, the warning information, and the location information is temporarily stored. Furthermore, in the data storage area 404, address book data including contact information is stored, and another flag and a timer (counter) required in execution of the programs are provided.

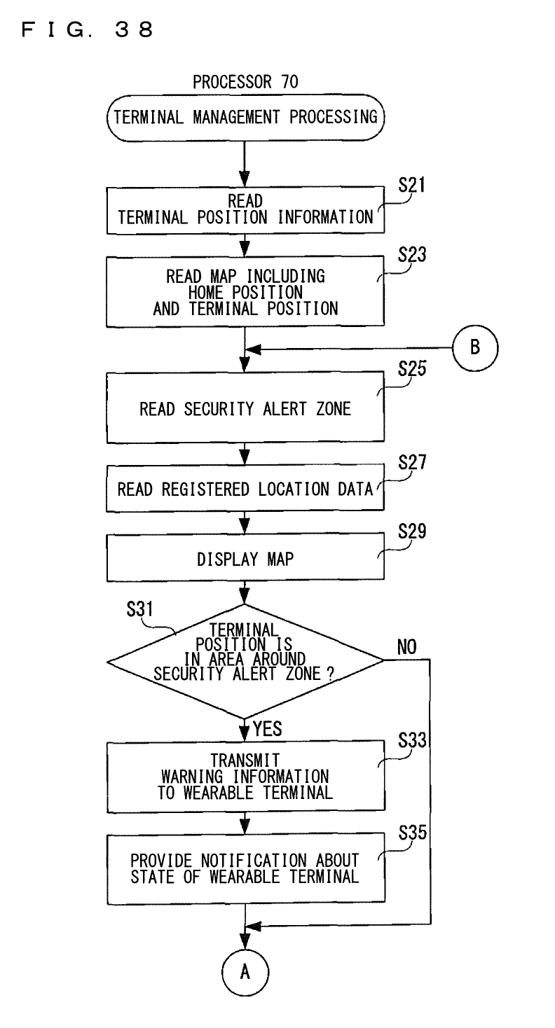

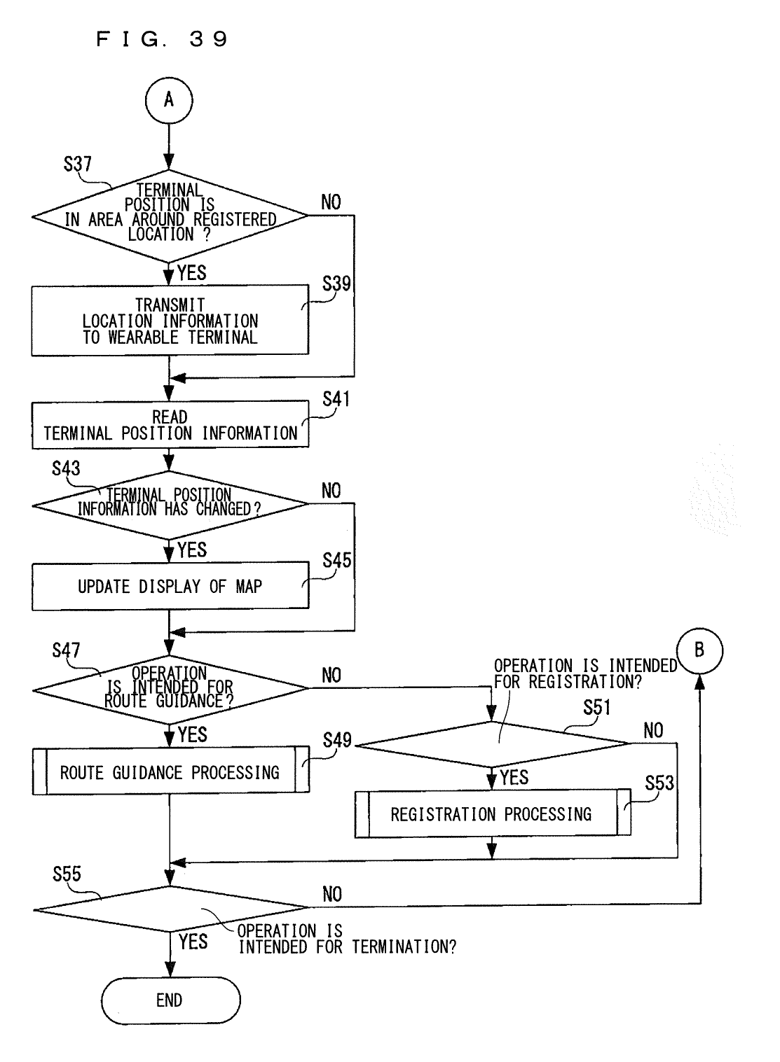

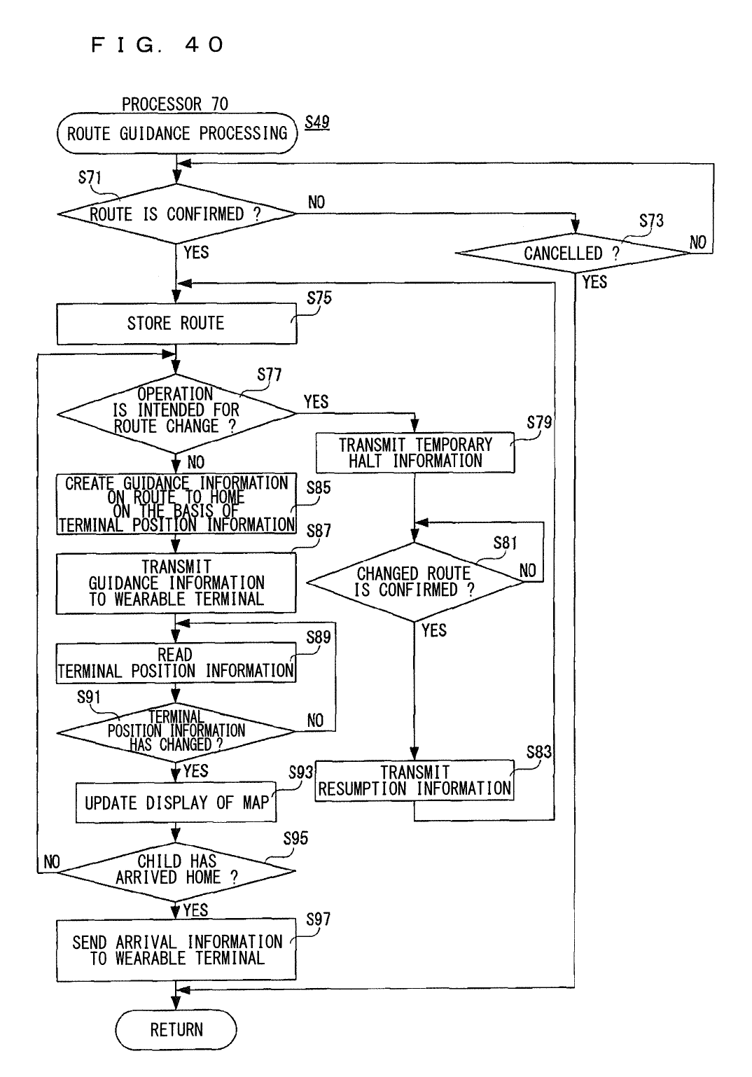

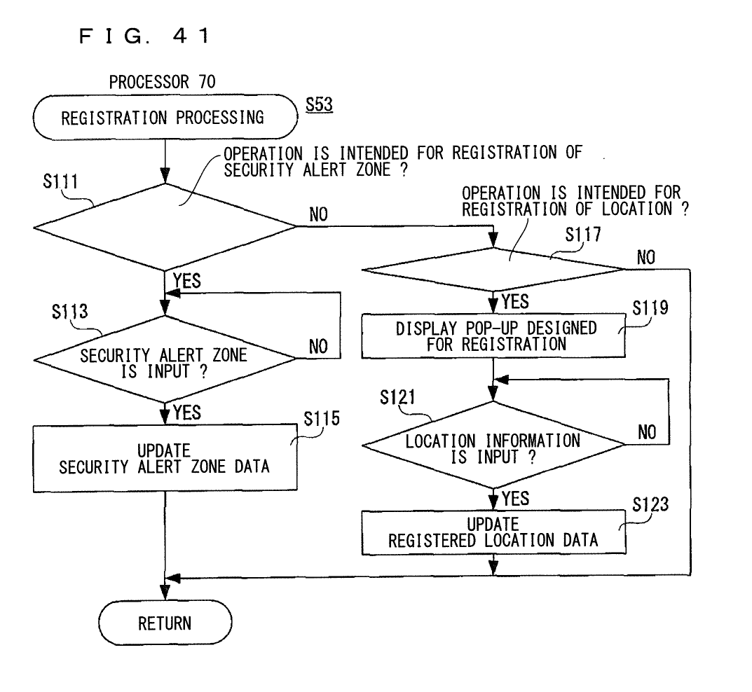

The processor 70 of the mobile phone 10 performs, in parallel, a plurality of tasks including a terminal position information management processing in FIG. 37, a terminal management processing in FIGS. 38 and 39, a route guidance processing in FIG. 40, and a registration processing in FIG. 41 under control by a predetermined operation system (OS), namely, an OS based on Windows®, an OS based on Linux® such as Android®, or iOS®.

FIG. 37 illustrates a flowchart showing the terminal position information management processing. For example, the terminal position information management processing is started when the power of the mobile phone 10 is turned on. In Step S1, the processor 70 determines whether the terminal position information is received. That is, the processor 70 determines whether the mobile phone 10 receives the terminal position information including the terminal position, the posture, and the azimuth from the wearable terminal 12. If “NO” in Step S1, or equivalently, if the terminal position information is not received from the wearable terminal 12, the processor 70 executes the processing in Step S1 again.

If “YES” in Step S1, or equivalently, if the terminal position information is received from the wearable terminal 12, the processor 70 stores the terminal position information in Step S3. That is, the received terminal position information is stored in the terminal position information buffer 332. When the processing in Step S3 is completed, the processor 70 returns to the processing in Step S1. That is, the processor 70 determines again whether the terminal position information is received. The terminal position information management processing is repeated at predetermined intervals (of, for example, five seconds).

The terminal position information management processing according to another embodiment may include the step of setting a warning mode, in which a warning sound is output after a lapse of a predetermined period over which the terminal position information cannot be received. If the terminal position information from the wearable terminal 12 cannot be received, the child is likely to be exposed to danger, and the parent is notified of this situation.

FIG. 38 illustrates part of a flowchart showing the terminal management processing. For example, when the management function is performed, the processor 70 reads the terminal position information in Step S21. That is, the terminal position information of the wearable terminal 12 is read from the terminal position information buffer 332. Subsequently, in Step S23, the processor 70 reads a map including the home position and the terminal position. That is, the map data 336 is read on the basis of the home position data 338 and the terminal position included in the terminal position information that has been read.

Then, the processor 70 reads the security alert zone data 340 in Step S25 and reads the registered location data 342 in Step S27. Subsequently, in Step S29, the processor 70 causes the display 24 to display a map. For example, as illustrated in FIG. 30, the display 24 displays a map including the terminal position icon C, the home position icon H, and the security alert zone D.

Subsequently, in Step S31, the processor 70 determines whether the terminal position is located in an area around the security alert zone. That is, a determination is made whether the child is close to the security alert zone. In particular, the processor 70 determines whether the terminal position is in the area around the security alert zone on the basis of the security alert zone data 340 that has been read and the terminal position included in the terminal position information. If “NO” in Step S31, or equivalently, if the child is not close to the security alert zone, the processor 70 proceeds to the processing in Step S37.

If “YES” in Step S31, or equivalently, if the child is close to the security alert zone, the processor 70 transmits the warning information to the wearable terminal 12 in Step S33. For example, the warning information advising the child to move away from the security alert zone is transmitted to the wearable terminal 12. Subsequently, in Step S35, the processor 70 provides a notification about the state of the wearable terminal 12. For example, as illustrated in FIG. 31, the display 24 displays the pop-up PU notifying that the child is approaching the security alert zone.

With reference to FIG. 39, the processor 70 determines, in Step S37, whether the terminal position is in an area around the registered location. That is, a determination is made whether the child is close to the registered location. In particular, the processor 70 determines whether the terminal position is in the area around the registered location on the basis of the registered location data 342 that has been read and the terminal position included in the terminal position information. If “NO” in Step S37, or equivalently, if the child is not close to the registered location, the processor 70 proceeds to the processing in Step S41. If “YES” in Step S37, or equivalently, if the child is close to the registered location, the processor 70 transmits the location information to the wearable terminal 12 in Step S39. For example, the location information including the image illustrated in FIG. 34 is transmitted to the wearable terminal 12.

Subsequently, in Step S41, the processor 70 reads the terminal position information. That is, the terminal position information is read from the terminal position information buffer 332 again. Then, in Step S43, the processor 70 determines whether the terminal position information has changed. For example, a determination is made whether the position of the child has changed. If “NO” in Step S43, or equivalently, if the position of the child has not changed, the processor 70 proceeds to the processing in Step S47. If “YES” in Step S43, or equivalently, if the position of the child has changed, the processor 70 updates the display of the map in Step S45. For example, the display of the terminal position icon C on the map is updated.

Subsequently, in Step S47, the processor 70 determines whether the operation is intended for the route guidance. For example, a determination is made whether a tap is performed on the terminal position icon C. If “YES” in Step S47, or equivalently, if a tap is performed on the terminal position icon C, the processor 70 executes the route guidance processing in Step S49. Upon completion of the processing in Step S49, the processor 70 proceeds to the processing in Step S55. The route guidance processing will be described in detail with reference to the flowchart in FIG. 40, and thus the detailed description thereof is not given here for brevity.

If “NO” in Step S47, or equivalently, if a tap is not performed on the terminal position icon C, the processor 70 determines whether the operation is intended for the registration in Step S51. For example, a determination is made whether a tap is performed on a point other than the terminal position icon C or whether a slide operation is performed on a given point. If “YES” in Step S51, or equivalently, if a slide operation is performed on a given point, the processor 70 executes the registration processing in Step S53. Upon completion of the registration processing, the processor 70 proceeds to the processing in Step S55. The registration processing will be described in detail with reference to the flowchart in FIG. 41, and thus the detailed description thereof is not given here for brevity.

If “NO” in Step S51, or equivalently, if the registration operation is not performed, the processor 70 determines whether the operation is intended for termination in Step S55. For example, a determination is made whether the operation of terminating the management function is performed. If “NO” in Step S55, or equivalently, if the operation of terminating the management function is not performed, the processor 70 returns to the processing in Step S25. If “YES” in Step S55, or equivalently, if the operation of terminating the management function is performed, the processor 70 terminates the terminal management processing.

FIG. 40 illustrates a flowchart showing the route guidance processing. When the processing in Step S49 is executed in the terminal management processing, the route guidance processing is started. In Step S71, the processor 70 determines whether the route is confirmed. For example, a determination is made whether a tap operation is performed on the home position icon H after the slide operation of inputting a route is performed as illustrated in FIGS. 17 to 20. If “NO” in Step S71, or equivalently, if the route is not confirmed, the processor 70 determines, in Step S73, whether the route is cancelled. For example, a determination is made whether a certain period of time has elapsed without any input being received. If “YES” in Step S73, or equivalently, if a certain period of time has elapsed without any input being received, the processor 70 terminates the route guidance processing and returns to the terminal management processing. If “NO” in Step S73, or equivalently, if a certain period of time has not elapsed without any input being received, the processor 70 returns to the processing in Step S71.

If “YES” in Step S71, or equivalently, if a route is input and then a tap operation is performed on the home position icon H, the processor 70 stores a route in Step S75. If the input of the route is confirmed as illustrated in FIG. 20, the route is stored in the route buffer 334. When the route is stored, the display 24 displays the pop-up PU notifying that the input route is confirmed.

Subsequently, in Step S77, the processor 70 determines whether the operation is intended for a route change. That is, a determination is made whether a tap is performed on the terminal position icon C. The processor 70 executing the processing in Step S77 functions as an acceptor. If “YES” in Step S77, or equivalently, if a tap is performed on the terminal position icon C as illustrated in FIG. 25, the processor 70 transmits the temporary halt information in Step S79. For example, the temporary halt information providing instructions to stay at the current position is transmitted to the wearable terminal 12. Subsequently, in Step S81, the processor 70 makes a determination whether the changed route is confirmed. For example, a determination is made whether a tap operation is performed on the home position icon H after a slide operation of inputting the changed route is performed. If “NO” in Step S81, or equivalently, if the changed route is not confirmed, the processor 70 executes the processing in Step S81 again. If “YES” in Step S81, or equivalently, if a tap operation is performed on the home position icon H after the changed route is input, the processor 70 transmits the resumption information in Step S83. For example, the resumption information notifying that the route guidance is resumed is transmitted to the wearable terminal 12. Then, the processor 70 returns to the processing in step S75. In the processing in step S75, the changed route is stored in the route buffer 334.

If “NO” in Step S77, or equivalently, if an operation of changing the route is not performed, the processor 70 creates, in Step S85, guidance information on a route to home on the basis of the terminal position information. For example, the processor 70 computes the position on the route with reference to the terminal position included in the terminal position information and the route stored in the route buffer 334, and computes the right direction on the route on the basis of the posture and the azimuth included in the terminal position information. Then, the guidance information is created on the basis of the position and the right direction on the route that have been computed in such a manner. The processor 70 executing the processing in Step S85 functions as a creator. Subsequently, in Step S87, the processor 70 transmits the guidance information to the wearable terminal 12.

Subsequently, in Step S89, the processor 70 reads the terminal position information. Then, in Step S91, the processor 70 determines whether the terminal position information has changed. For example, a determination is made whether the position of the child has changed. If “NO” in Step S91, or equivalently, if the position of the child has not changed, the processor 70 returns to the processing in Step S89. If “YES” in Step S91, or equivalently, if the position of the child has changed, the processor 70 updates the display of the map in Step S93. For example, the display of the terminal position icon C is updated.

Subsequently, in Step S95, the processor 70 determines whether the child has arrived home. That is, a determination is made whether the terminal position is in close agreement with the home position. In particular, a determination is made whether the child has arrived home on the basis of the home position data 338 and the terminal position included in the terminal position information. If “NO” in Step S95, or equivalently, if the child has not arrived home, the processor 70 returns to the processing in Step S77. That is, the route guidance is provided.

If “YES” in Step S95, or equivalently, if the child has arrived home, the processor 70 transmits the arrival information to the wearable terminal 12 in Step S97. That is, the arrival information notifying that the child has arrived home is transmitted to the wearable terminal 12. Upon completion of the processing in Step S97, the processor 70 ends the route guidance processing and returns to the terminal management processing. In another embodiment, the display 24 of the mobile phone 10 may display the pop-up PU providing a notification of the child's arrival in step with the transmission of the arrival information.

FIG. 41 illustrates a flowchart showing the registration processing. When the processing in Step S53 in the terminal management processing is executed, the processor 70 determines, in Step S111, whether the operation is intended for the registration of a security alert zone. That is, a determination is made whether a slide operation has been performed at a given position. If “YES” in Step S111, or equivalently, if a slide is performed on a given position, the processor 70 determines, in Step S113, whether a security alert zone is input to the mobile phone 10. That is, a determination is made whether a touch operation of inputting a security alert zone is performed. If “NO” in Step S113, or equivalently, if a security alert zone is not input, the processor 70 executes the processing in Step S113 again. If “YES” in Step S113, or equivalently, if a security alert zone is input to the mobile phone 10, the processor 70 updates the security alert zone data 340 in Step S115. That is, the newly input security alert zone is added to the security alert zone data 340 including security alert zones that have been already registered. Upon completion of the processing in Step S115, the processor 70 ends the registration processing and returns to the terminal management processing. The processor 70 executing the processing in Step S115 functions as a first registration unit.

If “NO” in Step S111, or equivalently, if the operation is not intended for the registration of a security alert zone, the processor 70 determines, in Step S117, whether the operation is intended for the registration of a security alert location. That is, a determination is made whether a tap is performed on a given position. If “NO” in Step S117, or equivalently, if the touched position corresponds to a place (such as the sea) that cannot be input as a security alert zone nor be registered as a security alert location, the processor 70 ends the registration processing and returns to the terminal management processing. If “YES” in Step S117, or equivalently, if a tap is performed on a given position as illustrated in FIG. 32, the processor 70 causes the display 24 to display the pop-up PU designed for registration in Step S119. For example, the display 24 displays the pop-up PU illustrated in FIG. 33. Subsequently, in Step S121, the processor 70 determines whether the location information is input to the mobile phone 10. That is, the processor 70 determines whether the operation of registering location information indicating the state of the area around the registered location is performed. If “NO” in Step S121, or equivalently, if the operation of registering location information is not performed, the processor 70 executes the processing in Step S121 again. If “YES” in Step S121, or equivalently, if the operation of inputting location information is performed, the processor 70 updates the registered location data in Step S123. For example, the processor 70 adds, as one piece of data, the coordinates of the tapped position and the registered location information to the registered location data 342. Upon completion of the processing in Step S124, the processor 70 ends the registration processing and returns to the terminal management processing. The processor 70 executing the processing in Step S123 functions as a second registration unit.

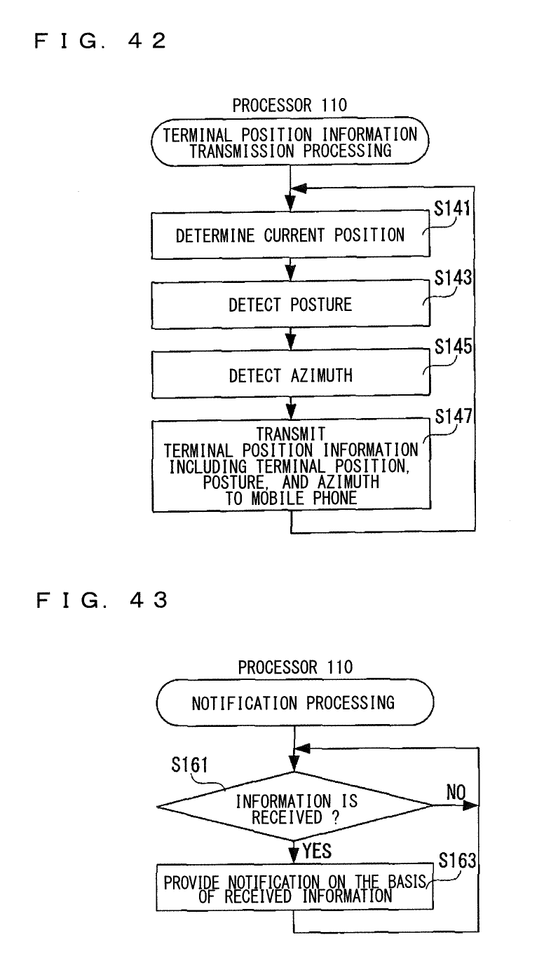

The processor 110 of the wearable terminal 12 performs, in parallel, a plurality of tasks including a terminal position information transmission processing in FIG. 42 and a notification processing in FIG. 43 under control by a predetermined OS, namely, an OS based on Linux® such as Android® or iOS®.

FIG. 42 illustrates a flowchart showing the terminal position information transmission processing. For example, the terminal position information transmission processing is executed when the power of the wearable terminal 12 is turned on. In Step S141, the processor 110 determines the current position. That is, the current position of the wearable terminal 12 is determined through the use of GPS signals from GPS satellites. Subsequently, in Step S143, the processor 110 detects the posture. That is, the posture of the wearable terminal 12 is detected on the basis of the output from the posture sensor 134. Then, in Step S145, the processor 110 detects the azimuth. That is, the azimuth of the wearable terminal 12 (the orientation of the child) is detected on the basis of the output from the azimuth sensor 132. The terminal position, the posture, and the azimuth are stored in the terminal position information buffer 430.

Subsequently, in Step S147, the processor 110 transmits the terminal position information including the terminal position, the posture, and the azimuth to the mobile phone 10. That is, the processor 110 creates the terminal position information including the terminal position, the posture, and the azimuth stored in the terminal position information buffer 430, and transmits the terminal position information to the mobile phone 10. Upon completion of the processing in Step S147, the processor 110 returns to the processing in Step S141. The terminal position information transmission processing is repeated at predetermined intervals equal to the predetermined intervals at which the terminal position information management processing is repeated.

FIG. 43 illustrates a flowchart showing the notification processing. For example, the notification processing is executed when the power of the wearable terminal 12 is turned on. In Step S161, the processor 110 determines whether the information is received. That is, a determination is made whether information received from the mobile phone 10, such as the warning information, the location information, the guidance information, the temporary halt information, the resumption information, or the arrival information, is stored in the communication buffer 432. If “NO” in Step S161, or equivalently, if the above-mentioned information is not received, the processor 110 executes the processing in Step S161 again. If “YES” in Step S161, or equivalently, if at least one piece of the above-mentioned information is received, the processor 110 provides notification in Step S163 on the basis of the received information. For example, if the guidance information is received, the display 42 of the wearable terminal 12 displays the message advising the child to turn left with respect to the heading direction of the child and the icon indicating the left as illustrated in FIG. 22. The processor 110 causes the display 42 to display the information, and causes the wearable terminal 12 to vibrate by activating the vibrator 136. Upon completion of the processing in Step S163, the processor 110 returns to the processing in Step S161.

The processor 70 executing the processing in Steps S33 and S39 and the processor 110 executing the processing in Step S163 each function as a specific information notification provider. To be more specific, the processor 70 executing the processing in Step S33 and the processor 110 executing the processing in Step S163 each function as a warning information notification provider. The processor 70 executing the processing in Step S39 and the processor 110 executing the processing in Step S163 each function as a location information notification provider. The processor 70 executing the processing in Step S79 and the processor 110 executing the processing in Step S163 each function as a temporary halt notification provider. The processor 70 executing the processing in Step S83 and the processor 110 executing the processing in Step S163 each function as a resumption notification provider. The processor 70 executing the processing in Step S87 and the processor 110 executing the processing in Step S163 each function as a guidance provider.

### Second Embodiment

In a second embodiment, a plurality of children wear their own wearable terminals 12 and a meeting point is set for the children, who can be guided to home in accordance with the route guidance. The configuration of the route guidance system 100 according to the second embodiment is substantially the same as the configuration of the route guidance system 100 in the first embodiment. Thus, for simplicity, the configuration of the system as well as the mobile phone 10 and the wearable terminals 12 included in the system will not be described below in detail. The individual wearable terminal 12 is also referred to as a wearable terminal 12a or a wearable terminal 12b.

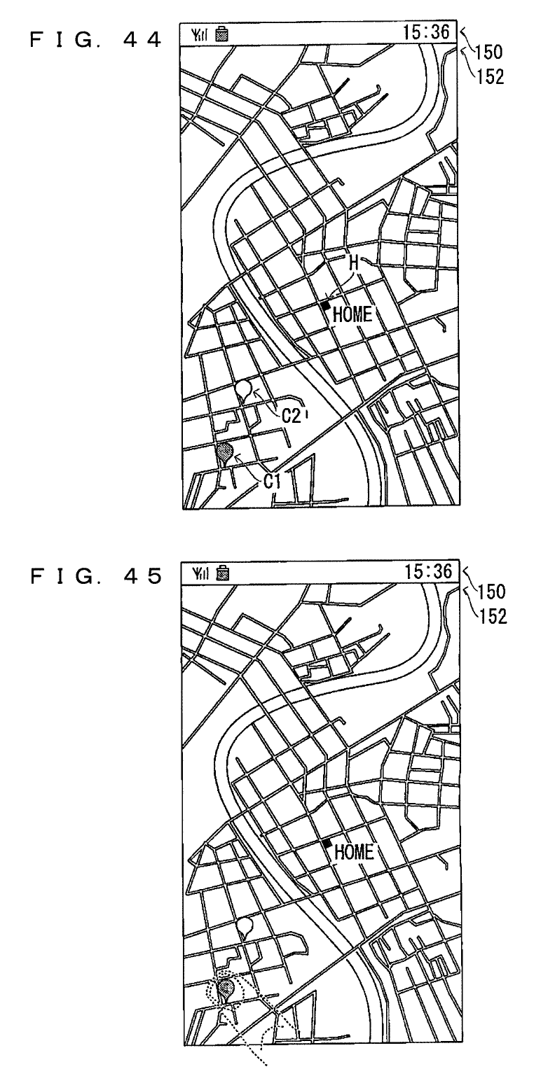

With reference to FIG. 44, assume that the older brother wears a first wearable terminal 12a, which is also referred to as a third mobile terminal, and the younger brother in another place wears a second wearable terminal 12b, which is also referred to as a fourth mobile terminal. When the mobile phone 10 of the parent executes the management function in this state, the display 24 displays a map including the home position icon H and the current positions of the two children, namely, a first terminal position icon C1 corresponding to a first terminal position of the first wearable terminal 12a and a second terminal position icon C2 corresponding to a second terminal position of the second wearable terminal 12b. Description will be given on the route guidance intended to assist the older brother wearing the first wearable terminal 12a and the younger brother wearing the second wearable terminal 12b in meeting each other on the way and to guide the brothers to home.

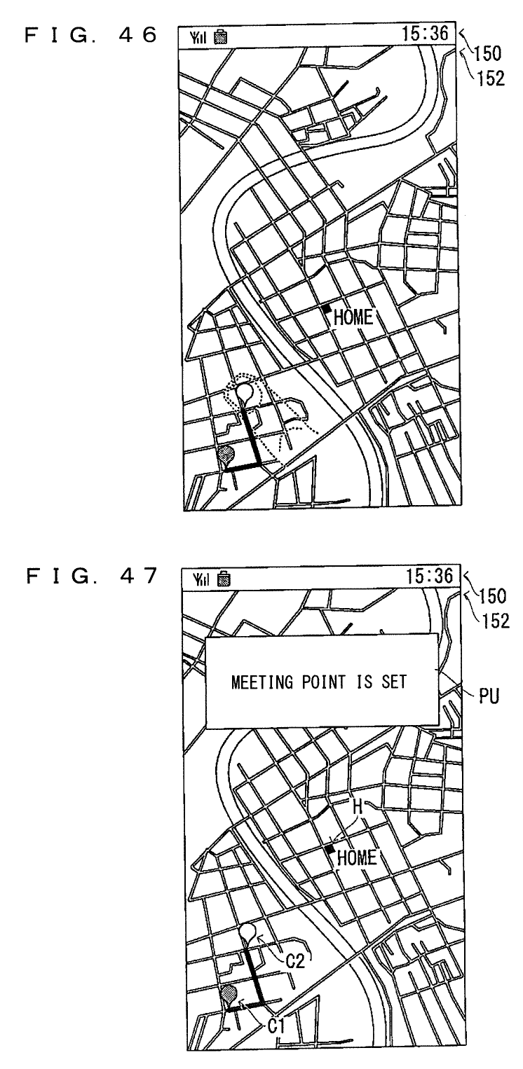

As illustrated in FIG. 45, in response to a tap operation on the first terminal position icon C1, the mobile phone 10 sets the position corresponding to the second terminal position icon C2 as a meeting point and becomes ready to accept input of a route including the meeting point. With the mobile phone 10 being in this state, in a case where a route from the first terminal position icon C1 to the second terminal position icon C2 is input and a tap operation is subsequently performed on the second terminal position icon C2 as illustrated in FIG. 46, the second terminal position is set as the meeting point as illustrated in FIG. 47. In a case where a route to home is input after the setting of the meeting point, the route including the meeting point is stored as in the first embodiment. Subsequent to the storing of the route, the route guidance is started.

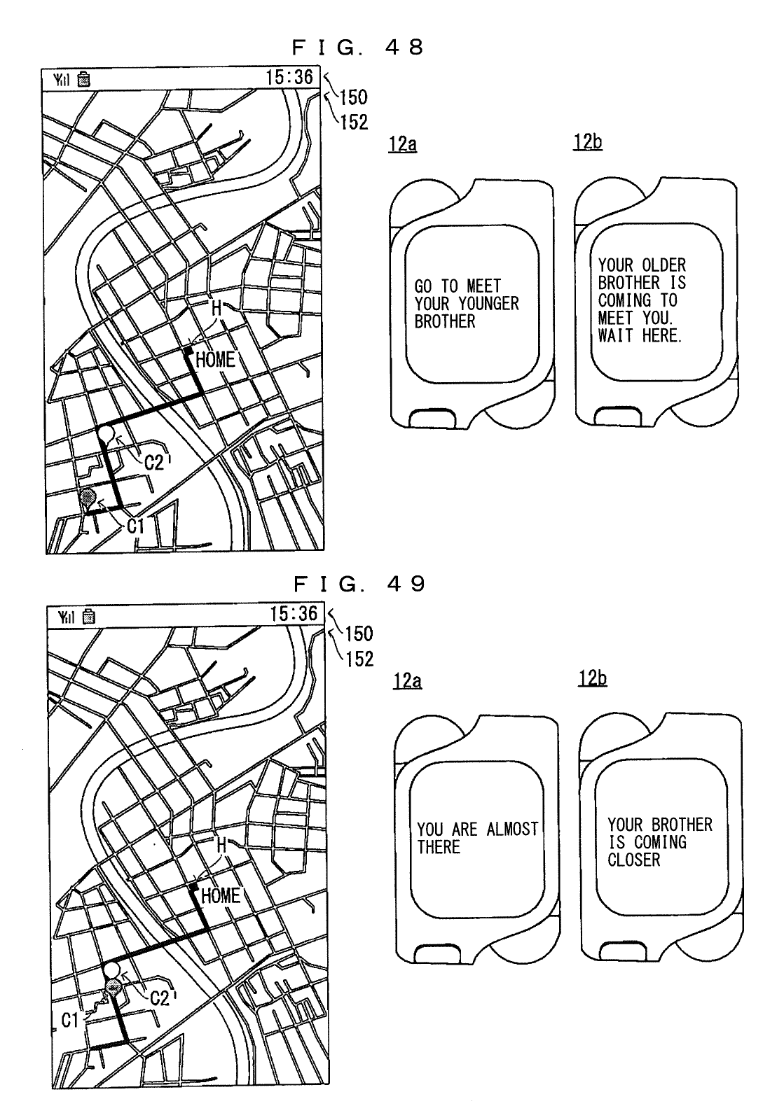

As illustrated in FIG. 48, when the route guidance is started, the guidance information notifying that the route guidance is started is transmitted to the first wearable terminal 12a and the guidance information providing instructions to wait at the current position is transmitted to the second wearable terminal 12b. If the younger brother wearing the second wearable terminal 12b moves away from the meeting point, the older brother wearing the first wearable terminal 12a probably fails to meet the younger brother when reaching the meeting point. Thus, in the second embodiment, the younger brother who is at the meeting point is instructed to wait there. This allows the brothers to easily meet at the meeting point.

The mobile phone 10 creates guidance information on a route from the first terminal position icon 01 indicating the first wearable terminal 12a to the meeting point (the second terminal position icon C2). Thus, the route guidance is provided to guide the older brother wearing the first wearable terminal 12a to the meeting point as in the first embodiment. As illustrated in FIG. 49, when the older brother approaches the meeting point in accordance with the route guidance, the guidance information notifying that the first wearable terminal 12a is close to the meeting point is transmitted to the individual wearable terminals 12 worn by the brothers.

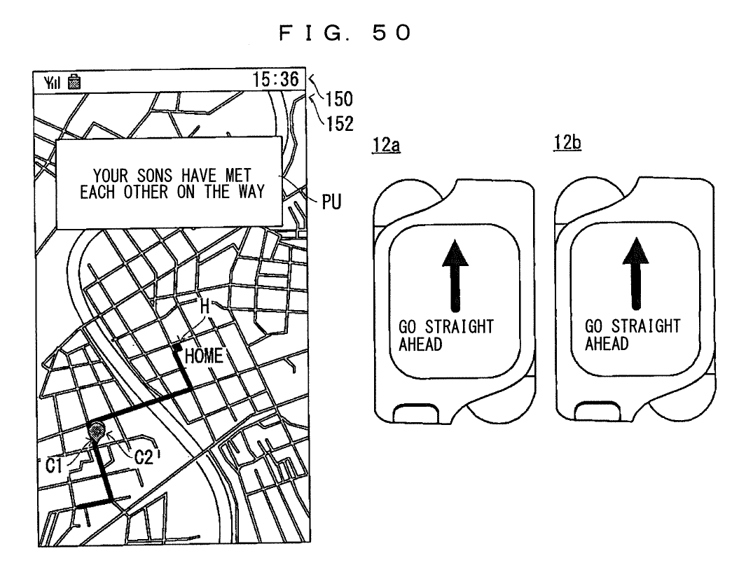

When the older brother wearing the first wearable terminal 12a reaches the meeting point, the display 24 of the mobile phone 10 displays, as illustrated in FIG. 50, the pop-up PU notifying that the brothers have met on the way. The mobile phone 10 creates guidance information on a route from the meeting point to home and transmits the guidance information to the individual wearable terminals 12. The wearable terminals 12 worn by the brothers receive the same guidance information. After the brothers meet each other, the route guidance is provided to guide the brothers from the meeting point to home as in the first embodiment.

As described above, the route guidance is provided to guide the older brother to the meeting point until he meets his younger brother. This route guidance assists the brothers in meeting each other on the way. After meeting each other, the brothers can go home by following the appropriate route.

In the second embodiment, the parent can change the route during the route guidance as in the first embodiment.

In the second embodiment, when a determination is made that the two children have met each other on the way, a voice call may be established between the first wearable terminal 12a and the second wearable terminal 12b. The children who are determined to be at the same position on the map possibly fail to meet each other in actuality, and thus a voice call is established between the two wearable terminals 12 such that the children can certainly meet each other.

In the second embodiment, when a determination is made that the two children have met each other on the way, the guidance information may be transmitted to one of the wearable terminals 12 of the children. For example, the guidance information may be transmitted only to the first wearable terminal 12a of the older brother.

In another embodiment, three or more children may be instructed to gather at one point or several children may be gathered at several meeting points in a step-by-step manner, and then the children may be guided to home. It is not required that all or some of the children be gathered and the children may be guided to home in accordance with individual routes.

In still another embodiment, the meeting point may be set at a position other than the position corresponding to the second terminal position icon C2. In this case, the route guidance is also provided to guide the younger brother wearing the second wearable terminal 12b to the meeting point.

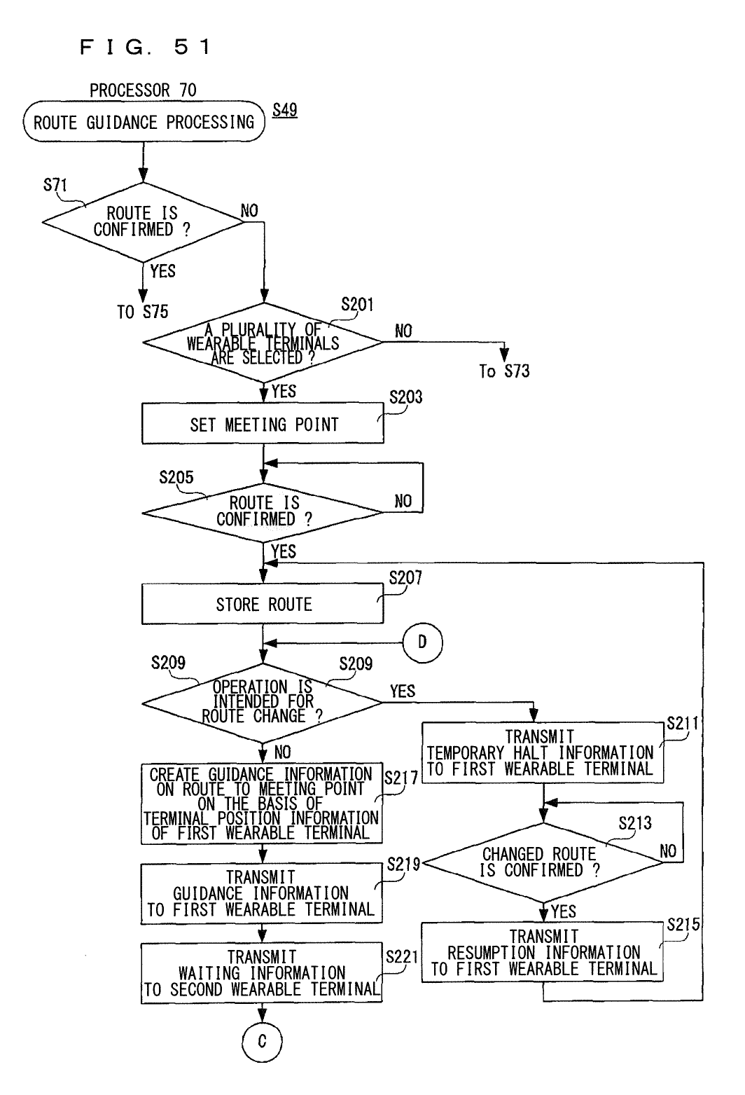

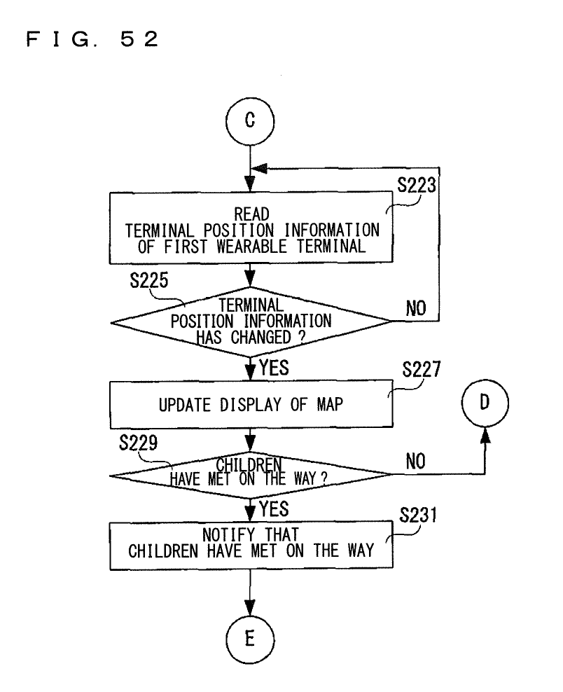

The above description has provided an overview of the features of the second embodiment. The second embodiment will be described below with reference to the flowcharts illustrated in FIGS. 51 to 53.

FIG. 51 illustrates part of a flowchart showing the route guidance processing according to the second embodiment. The steps (processing) in which the route guidance processing of the second embodiment overlaps that of the first embodiment will be omitted from the following description.

When the route guidance processing in the second embodiment is executed, the processor 70 determines, in Step S71, whether the route is confirmed. If “YES” in Step S71, the processor 70 executes the processing in Step S75 and subsequent steps. This means that the route guidance in the first embodiment is performed in response to the confirmation of the route.

If “NO” in Step S71, the processor 70 determines, in Step S201, whether a plurality of wearable terminals 12 are selected. For example, a determination is made whether a tap operation is performed on another terminal position icon C while the route is input as illustrated in FIG. 46. If “NO” in Step S201, or equivalently, if the plurality of wearable terminals 12 are not selected, the processor 70 proceeds to the processing in Step S73.

If “YES” in Step S201, or equivalently, if a tap operation is performed on another terminal position icon C, the processor 70 sets a meeting point in Step S203. For example, the second terminal position is stored in the route buffer 334 as the meeting point. Subsequently, in Step S205, the processor 70 determines whether the route is confirmed. That is, a determination is made whether a tap operation is performed on the home position icon H. If “NO” in Step S205, or equivalently, if the route is not confirmed, the processor 70 executes the processing in Step S205 again.

If “YES” in Step S205, or equivalently, if a tap operation is performed on the home position icon H to confirm the route, the processor 70 stores the route in Step S207. That is, the confirmed route is stored in the route buffer 334. The processor 70 executing the processing in Steps S203 and S207 functions as a storage.

Subsequently, in Step S209, the processor 70 determines whether the operation is intended for a route change. That is, as in the processing in Step S77 in the first embodiment, a determination is made whether an operation of changing the route is performed. If “YES” in Step S209, or equivalently, an operation of changing the route is performed, the processor 70 transmits the temporary halt information to the first wearable terminal 12a in Step S211. That is, the temporary halt information is transmitted to the first wearable terminal 12a receiving the guidance information. Subsequently, in Step S213, the processor 70 determines whether the route is confirmed as in the processing in Step S81 in the first embodiment. If “NO” in Step S213, or equivalently, if the changed route is not confirmed, the processor 70 executes the processing in Step S213 again. If “YES” in Step S213, or equivalently, if the changed route is confirmed, the processor 70 transmits the resumption information to the first wearable terminal 12a in Step S215. That is, in response to the confirmation of the changed route, the resumption information is transmitted to the first wearable terminal 12a that has received the temporary halt information. Upon completion of the processing in Step S215, the processor 70 returns to the processing in Step S205. Then, the changed route is stored in the route buffer 334.

If “NO” in Step S209, or equivalently, if an operation of changing the route is not performed, the processor 70 creates, in Step S217, guidance information on a route to the meeting point on the basis of the terminal position information of the first wearable terminal 12a. For example, the guidance information for guiding the older brother wearing the first wearable terminal 12a to the meeting point is created. The processor 70 executing the processing in Step S217 functions as a first creator. Subsequently, in Step S219, the processor 70 transmits the guidance information to the first wearable terminal 12a. Then, in Step S221, the processor 70 transmits waiting information to the second wearable terminal 12b. For example, the waiting information is transmitted to the second wearable terminal 12b to instruct the younger brother wearing the second wearable terminal 12b to stay there.

With reference to FIG. 52, the processor 70 subsequently reads the terminal position information of the first wearable terminal 12a in Step S223. Then, in Step S225, the processor 70 determines whether the terminal position information has changed. For example, a determination is made whether the position of the older brother wearing the first wearable terminal 12a in receipt of the guidance information has changed. If “NO” in Step S225, or equivalently, if the position of the older brother has not changed, the processor 70 returns to the processing in Step S223. If “YES” in Step S225, or equivalently, if the position of the older brother has changed, the processor 70 updates the display of the map in Step S227. For example, the processor 70 updates the first terminal position icon C1 on the map on the basis of the terminal position information of the first wearable terminal 12a.

Subsequently, in Step S229, the processor 70 determines whether the brothers have met each other on the way. For example, a determination is made whether the older brother wearing the first wearable terminal 12a has reached the meeting point. In particular, the processor 70 determines whether the terminal position of the first wearable terminal 12a stored in the terminal position information buffer 332 is in close agreement with the meeting point stored in the route buffer 334. The processor 70 executing the processing in Step S229 functions as a determiner. If “NO” in Step S229, or equivalently, if the brothers have not met each other on the way, the processor 70 returns to the processing in Step S209. If “YES” in Step S229, or equivalently, if the brothers have met each other on the way, the processor 70 notifies, in step S231, that the brothers have met each other on the way. For example, as illustrated in FIG. 50, the display 24 of the mobile phone 10 displays the pop-up PU notifying that the brothers have met each other on the way. The processor 70 executing the processing in Step S231 functions as a meeting notification provider.

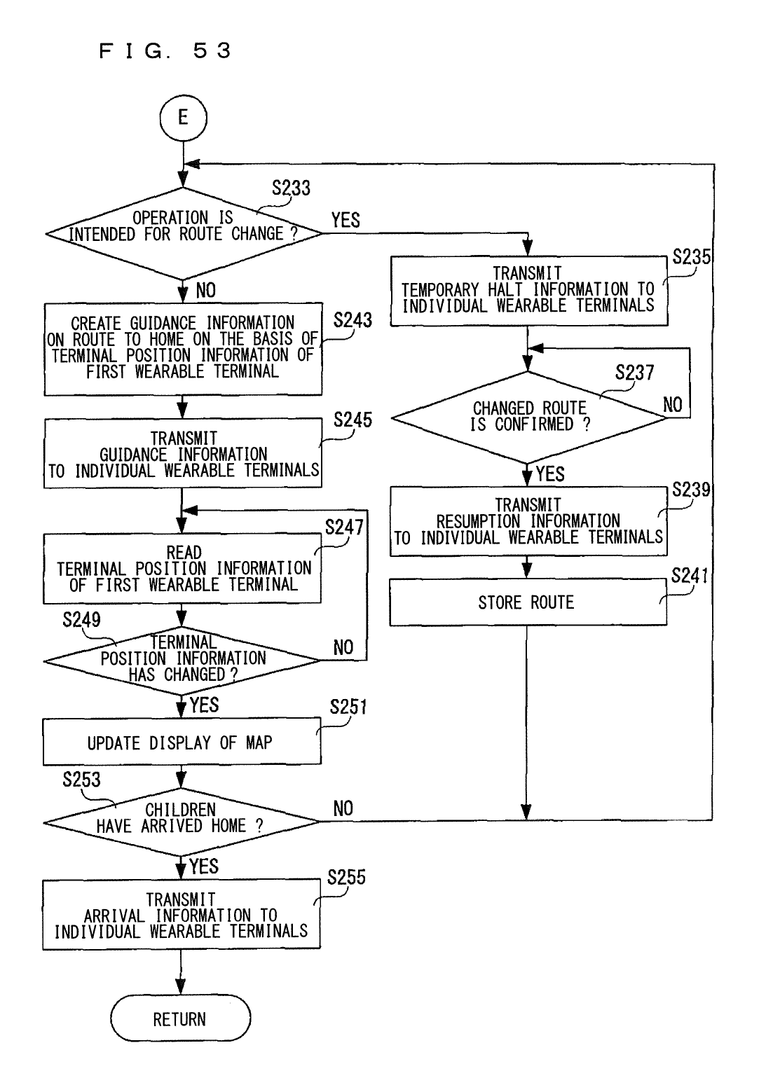

With reference to FIG. 53, the processor 70 subsequently determines whether the operation is intended for a route change in Step S233 as in the processing in Step S77. If “YES” in Step S233, or equivalently, if an operation of changing the route is performed, the processor 70 transmits the temporary halt information to the individual wearable terminals 12 in Step S235. If the brothers have met each other on the way, the temporary halt information is transmitted to the individual wearable terminals 12 worn by the brothers. Subsequently, in Step S237, the processor 70 determines whether the changed route is confirmed as in the processing in Step S81. If “NO” in Step S237, or equivalently, if the changed route is not confirmed, processor 70 executes the processing in Step S237 again. If “YES” in Step S237, or equivalently, if the changed route is confirmed, the processor 70 transmits the resumption information to the individual wearable terminals 12 in Step S239. For example, the brothers are notified of the resumption of the route guidance. Then, in Step S241, the processor 70 stores the route. That is, the changed route is stored in the route buffer 334. Upon completion of the processing in Step S241, the processor 70 returns to the processing in Step S233.

If “NO” in Step S233, or equivalently, if an operation of changing the route is not performed, the processor 70 creates, in Step S243, guidance information on a route to home on the basis of the terminal position information of the first wearable terminal 12a. If the brothers have met each other on the way, guidance information for guiding the brothers to the home position is created. The processor 70 executing the processing in Step S243 functions as a second creator. Subsequently, in Step S245, the processor 70 transmits the guidance information to the individual wearable terminals 12. That is, the same guidance information is transmitted to the brothers who have met each other on the way.

Subsequently, in Step S247, the processor 70 reads the terminal position information of the first wearable terminal 12a. Then, in Step S249, the processor 70 determines whether the terminal position information has changed. For example, a determination is made whether the positions of the brothers have changed on the basis of the changes in the terminal position information of the first wearable terminal 12a. If “NO” in Step S249, or equivalently, if the positions of the brothers have not changed, the processor 70 returns to the processing in Step S247. If “YES” in Step S249, or equivalently, if the positions of the brothers have changed, the processor 70 updates the display of the map in Step S251. For example, the first terminal position icon C1 and the second terminal position icon C2 on the map are updated.

Subsequently, in Step S253, the processor 70 determines whether the brothers have arrived home as in Step S95 in the first embodiment. If “NO” in Step S253, or equivalently, if the brothers have not arrived home, the processor 70 returns to the processing in Step S233. If “YES” in Step S235, or equivalently, if the brothers have arrived home, the processor 70 transmits the arrival information to the individual wearable terminals 12 in Step S255. That is, the arrival information notifying that the brothers have arrived home is transmitted to the individual wearable terminals 12. Upon completion of the processing in Step S255, the processor 70 ends the route guidance processing and returns to the terminal management processing as in the first embodiment.

In the route guidance processing according to the second embodiment, the processing of creating the guidance information and determining whether the positions have changed is still executed after the meeting of the brothers on the basis of the terminal position information of the first wearable terminal 12a. In another embodiment, this processing may be executed on the basis of the terminal position information of the second wearable terminal 12b.

The processor 110 executing the processing in Step S163 and the processor 70 executing the processing in Step S219 each function as a first guidance provider. The processor 110 executing the processing in Step S163 and the processor 70 executing the processing in Step S221 each function as a waiting notification provider. The processor 110 executing the processing in Step S163 and the processor 70 executing the processing in Step S245 each function as a second guidance provider.

The first embodiment and the second embodiment can be arbitrarily combined. Such combinations can be easily imagined, and thus the detailed description thereof is not given here for brevity.

In the above embodiments, the guidance information is created in the mobile phone 10, and the route guidance based on the guidance information is provided on the wearable terminal 12. Thus, the performance of the wearable terminal 12 can be minimized, and the price of the wearable terminal 12 can be minimized accordingly. In another embodiment, the route guidance may be provided as follows: the wearable terminal 12 stores the map data; an input route is transmitted to the wearable terminal 12; and the wearable terminal 12 creates the guidance information. This configuration can lighten the workload of the mobile phone 10, and can reduce the communication traffic accordingly.

In one embodiment, the home information is registered through the use of GPS signals. In another embodiment, the home position may be set by the parent designating the home position on the displayed map.

In a case where the child strays from the route, guidance information for bringing the child back to the route is created and the guidance information is provided on the wearable terminal 12.

In still another embodiment, it is not required that a map be displayed on the mobile phone 10 during the route guidance. In this case, a notification action is performed through the use of sound and light at the occurrence of an event, such as the child's arrival at home.

In still another embodiment, it is not required that the home be set as the destination in the route guidance. Alternatively, the current position of the mobile phone 10 may be set as the destination, or any place may be set as the destination when a route is input.

In still another embodiment, similarly to the display of the mobile phone 10, the display 42 of the wearable terminal 12 may display a map while the route guidance is provided on the wearable terminal 12.

In still another embodiment, during the route guidance, the wearable terminal 12 may provide instructions to walk with the eyes kept to the front. With an acceleration sensor being included in the wearable terminal 12, in a case where the posture sensor 134 detects the posture in which the wearable terminal 12 is checked and the acceleration sensor detects shifts in the position of the wearable terminal 12, the route guidance may be temporarily halted and a message instructing the child to stop may be displayed. If this is the case, the route guidance is resumed when no shift in the position of the wearable terminal 12 is detected.

In still another embodiment, without necessitating the biosensor 52, a determination may be made whether the wearable terminal 12 is taken off. For example, a magnetic sensor is embedded in the first belt 48a and a magnet is embedded in the second belt 48b. This configuration allows the magnetic sensor to detect the magnetism of the magnet when the wearable terminal 12 has the fitted shape. In this configuration, the magnetic sensor cannot detect the magnetism of the magnet if the wearable terminal 12 does not have the fitted shape. This means that the magnetic sensor fails to detect the magnetism of the magnet when the wearable terminal 12 is taken off, and thus the processor 110 can determine that the wearable terminal 12 is taken off.

In still another embodiment, a mechanical switch, instead of the magnetic sensor or the magnet, may be embedded in the base portion of the individual belt 48 such that the removal of the wearable terminal 12 can be determined. For example, the mechanical switch embedded in the base portion of the individual belt 48 is turned off if the wearable terminal 12 has the fitted shape and the mechanical switch is turned on if the wearable terminal 12 does not have the fitted shape. Thus, the processor 110 can determine whether the wearable terminal 12 is taken off on the basis of the on-off actions of the mechanical switches.

In addition to GPS signals transmitted from the GPS satellites, signals transmitted from the base station may be used to determine the current position in still another embodiment. Alternatively, signals transmitted from wireless LAN access points may be used in place of GPS signals.

The programs implemented in one embodiment may be stored in a hard disk drive (HDD) of a data distribution server and may be distributed to the mobile phone 10 and the wearable terminals 12 through the network. Non-transitory computer readable recording media including optical disks such as compact discs (CDs), DVDs, Blue-Ray Disks (BDs), USB memories, and memory cards may be sold or distributed, with a plurality of programs being stored in the recording media. The effects equal to those of one embodiment may be produced if the programs downloaded through the server or the recording media mentioned above are installed on mobile phones and wearable terminals having the configurations equivalent to the configurations of the mobile phone and the wearable terminal in one embodiment.

The specific numerical values mentioned herein are provided as merely an example, and therefore, may be appropriately changed in accordance with, for example, changes in product specifications.

While the route guidance system 100 has been described above in detail, the above description is in all aspects illustrative and not restrictive. In addition, various modifications described above are applicable in combination as long as they are not mutually inconsistent. It is understood that numerous modifications which have not been exemplified can be devised without departing from the scope of the present disclosure.

1. A route guidance system comprising:
a first mobile device that stores a route to a destination, the first mobile device comprising a transmitter and at least one first processor;
at least one second mobile device that acquires a device position of the at least one second mobile device itself;
wherein the at least one first processor is configured to
create guidance information on the basis of the device position, the route, and the destination; and
cause the transmitter to transmit route guidance to the at least one second mobile device on the basis of the guidance information.

2. The route guidance system according to claim 1,
wherein the at least one first processor
accepts an instruction of a route change from a user of the first mobile device, and
causes the transmitter to transmit, to the at least one second mobile device, a notification of a temporary halt on the route guidance when the instruction of the route change is accepted.

3. The route guidance system according to claim 2, wherein
the at least one second mobile device comprises at least one second processor,
when the route change is completed, the at least one first processor causes the transmitter to transmit, to the at least one second mobile device, a notification of a resumption of the route guidance, and
the at least one second processor notifies a user of the at least one second mobile device of the resumption of the route guidance on the basis of the notification of the resumption of the route guidance.

4. The route guidance system according to claim 1, wherein
the at least one first processor causes the transmitter to transmit warning information to the at least one second mobile device when the device position moves close to a specific place, and
the at least one second processor notifies a user of the at least one second mobile device of proximity to the specific place on the basis of the warning information.

5. The route guidance system according to claim 4, wherein the specific place includes an alert zone.

6. The route guidance system according to claim 5, wherein
the first mobile device comprises a memory, and
the at least one first processor registers the alert zone to the memory in response to a user's operation of registering the alert zone.

7. The route guidance system according to claim 1, wherein
the at least one first processor causes the transmitter to transmit, to the at least one second mobile device, location information indicating a state of an area around a specific place when the device position of the at least one second mobile device moves close to the specific place, and
the at least one second processor notifies a user of the at least one second mobile device of the location information.

8. The route guidance system according to claim 7, wherein
the first mobile device comprises a memory, and
the at least one first processor registers, in response to a user's operation of registering a location, the location to the memory.

9. The route guidance system according to claim 1, wherein
the at least one second mobile device comprises a plurality of the second mobile devices including a third mobile device and a fourth mobile device located apart from the third mobile device,
the first mobile device further comprises a memory configured to store a meeting point for the third mobile device and the fourth mobile device and a route including the meeting point when the route is designated on the first mobile device, and
the at least one first processor
creates first guidance information on the basis of a device position of the third mobile device, the route, and the meeting point,
causes the transmitter to transmit, to the third mobile device, route guidance on a route to the meeting point on the basis of the first guidance information,
determines whether the third mobile device and the fourth mobile device have met each other on the basis of the device position of the third mobile device and the meeting point, and
causes the transmitter to transmit, when determining that the third mobile device and the fourth mobile device have met each other, a notification of the meeting to the first mobile device.

10. The route guidance system according to claim 9,
wherein the at least one first processor
creates second guidance information on the basis of the device position of the third mobile device or a device position of the fourth mobile device, the route, and the destination when determining that the third mobile device and the fourth mobile device have met each other, and
transmits, to the third mobile device, route guidance on a route to the destination on the basis of the second guidance information.

11. The route guidance system according to claim 9, wherein the at least one first processor transmits a notification of waiting to the fourth mobile device while the route guidance on the route to the meeting point is transmitted to the third mobile device.

12. A route guidance method in a route guidance system including a first mobile device that receives input of a route to a destination and at least one second mobile device that acquires a device position of the at least one second mobile device itself, the method comprising:
creating guidance information on the basis of the device position, the route, and the destination; and
providing route guidance on the at least one second mobile device on the basis of the guidance information.

13. A mobile device comprising:
a memory configured to store a route to a destination;
a receiver configured to receive a device position of another mobile device;
a transmitter; and
at least one processor configured to
create guidance information on the basis of the device position, the route, and the destination, and
cause the transmitter to transmit route guidance to the another mobile device on the basis of the guidance information.
